(19) United States
(12) Patent Application Publication
(10) Pub. No.: US 2021/0264370 A1
(43) Pub. Date: Aug. 26, 2021

(54) WORK PROJECT SYSTEMS AND METHODS

(71) Applicant: Zachry Intellectual Property Company, LLC, San Antonio, TX (US)

(72) Inventors: Patrick Edward Norton, Coppell, TX (US); Ranjeet Harjinder Gadhoke, San Antonio, TX (US)

(21) Appl. No.: 17/318,357

(22) Filed: May 12, 2021

Related U.S. Application Data
(63) Continuation of application No. 15/260,665, filed on Sep. 9, 2016, now abandoned.
(60) Provisional application No. 62/216,221, filed on Sep. 9, 2015.

(51) Int. Cl. G06Q 10/10; G06Q 10/06

(52) U.S. Cl. CPC G06Q 10/103; G06Q 50/08; G06Q 10/06313; G06Q 10/06398

(57) ABSTRACT

Work project systems may include one or more server and client computers configured to enable project management personnel to create and modify work plans, to capture time worked by the relevant personnel, to capture run times of equipment assigned to each work project, and to capture work progress quantities of completed work. Labor and equipment time may be recorded for each person and piece of equipment, respectively, for each element of each activity of each project on a daily basis, and the progress toward completion of actuals with respect to the budget or the plan may be tracked and viewed. As work is performed each day, the actual time spent and quantity of work accomplished by each laborer and piece of equipment on each activity may be recorded, and the actual amounts may be compared to the corresponding budget and plan in real-time. Performance factors may be calculated and viewed.

### CROSS-REFERENCE TO RELATED APPLICATIONS

This application claims priority to U.S. Provisional Application Ser. No. 62/216,221 filed Sep. 9, 2015, the disclosure of which is incorporated herein by reference.

### COPYRIGHT NOTICE

This application contains material that is subject to copyright protection. Such material may be reproduced exactly as it appears in Patent and Trademark Office patent files or records. The copyright owner otherwise reserves all rights to such material.

### FIELD

This application relates generally to the field of work project systems and methods, and more specifically to systems and methods for planning, executing, and evaluating labor, equipment and progress of installed quantities on various work projects, such as construction projects, for example.

### BACKGROUND

In the field of work project planning, execution, and evaluation, it is a challenge to timely and accurately keep track of labor and equipment usage along with the work progress quantities in a manner that is actually useful in managing tasks and budgets in connection with current work projects. Typically, in spite of very detailed work project planning and budgeting, the relevant information regarding usage of labor and equipment in performing the various tasks of work projects does not get captured or evaluated until well after a time at which it would have been useful to have in making a current work project more efficient. It would be a significant advancement in the art to provide a system and method by which labor and equipment usage along with the work progress quantities may be provided to work project managers in real-time with key performance indicators such as Performance Factor and Earned Value so that they may adjust schedules and resources as necessary or desirable to achieve more efficient execution of work projects.

### SUMMARY

As described herein, work project systems may include one or more server and client computers configured to enable project management personnel to create and modify work plans, to capture time worked by the relevant personnel, to capture run times of equipment assigned to each work project, and to capture work progress quantities of completed work. Labor and equipment time may be recorded for each person and piece of equipment, respectively, for each element of each activity of each project on a daily basis, and the progress toward completion of actuals with respect to the budget or the plan may be tracked and viewed. Mobile client computers may be configured to enable timekeepers to enter, review, and submit time worked on a project remotely from their smartphones or other mobile devices on a daily basis. Supervisory personnel with the appropriate credentials may also review, edit, and submit the time entries made by the various timekeepers under their supervision. As work is performed each day, the actual time spent and quantity of work accomplished by each laborer and piece of equipment on each activity may be recorded via a mobile application and communicated to a central server computer, and the actual amounts may be compared to the corresponding budget and plan in real-time. A performance factor of actual to budget or actual to plan may be calculated to indicate the performance of each laborer or timekeeper (e.g., foreman of a work crew) with respect to the budget or the plan for each activity and overall across all activities. Similarly, equipment performance factors may be calculated on the basis of run time, quantity of work accomplished, or other suitable metric. The results of all laborers or timekeepers on a project may also be combined in order to show overall performance on a given day, week, or other time period on the project, or for a given activity within a project. The recorded labor and equipment hours may be multiplied by the applicable labor and equipment cost rates, respectively, in order to calculate the actual labor and equipment costs for each laborer, timekeeper, and equipment for each activity each day, which may be displayed for appropriately credentialed personnel. Such labor and equipment performance and cost information may be displayed on the mobile client computers as numerical values, graphical indications (e.g., bar graphs, pie graphs, or the like), or other suitable indications.

In some embodiments, a work project system may include a server computer having a tangible computer readable medium with program instructions executable by the computer configured for: receiving labor data pertaining to a plurality of laborers, the labor data including a labor identifier and a labor role for each of the plurality of laborers; receiving equipment data pertaining to a plurality of equipment, the equipment data including an equipment identifier and an equipment role for each of the plurality of equipment; receiving work project data pertaining to a plurality of work projects, the work project data including a plurality of activities for each of the plurality of work projects; associating one or more of the plurality of laborers with each of the plurality of activities; associating one or more of the plurality of equipment with each of the plurality of activities; receiving actual time worked data at least once daily for each of the plurality of laborers, the actual time worked data being allocated to one or more of the plurality of activities; receiving actual run time data at least once daily for each of the plurality of equipment, the actual run time data being allocated to one or more of the plurality of activities; receiving actual work progress quantity data at least once daily for each of the plurality of laborers, the actual work progress quantity data being allocated to one or more of the plurality of activities; for each of the plurality of laborers, computing a labor earned value and a labor variance with respect to a budget for one or more of the plurality of activities using at least one of the actual time worked data and the actual work progress quantity data; for each of the plurality of laborers, computing a labor variance with respect to a plan for one or more of the plurality of activities using at least one of the actual time worked data and the actual work progress quantity data; for each of the plurality of equipment, computing an equipment earned value and an equipment variance with respect to the budget for one or more of the plurality of activities using the actual run time data; and communicating the labor earned value, the labor variance with respect to the budget, the labor variance with respect to the plan, the equipment earned value, and the equipment variance to at least one mobile client computer at least once daily, wherein the communicating occurs in real-time following receipt of the actual time worked data, the actual run time data, and the actual work progress quantity data.

In some embodiments, a work project system may include a mobile client computer having a tangible computer readable medium with program instructions executable by the computer configured for: communicating actual time worked data for a plurality of laborers to a central server computer at least once daily, the actual time worked data being allocated to one or more of a plurality of activities; communicating actual run time data for a plurality of equipment to the central server computer at least once daily, the actual run time data being allocated to one or more of the plurality of activities; communicating actual work progress quantity data for the plurality of laborers to the central server computer at least once daily, the actual work progress quantity data being allocated to one or more of the plurality of activities; receiving from the central server computer at least once daily a labor earned value, a labor variance with respect to a budget, a labor variance with respect to a plan, an equipment earned value, and an equipment variance; and displaying the labor earned value, the labor variance with respect to the budget, the labor variance with respect to the plan, the equipment earned value, and the equipment variance in real-time following the communicating of the actual time worked data, the actual run time data, and the actual work progress quantity data.

### BRIEF DESCRIPTION OF THE DRAWINGS

FIG. 1 is a functional overview of a work project system.

FIG. 2 is a technical overview of the work project system of FIG. 1.

FIG. 3 is a table of contents of a desktop application computer program for the work project system of FIG. 1.

FIG. 4 is a timecard home screen shot of the desktop application computer program of FIG. 3.

FIG. 5 is a timecard entry screen shot of the desktop application computer program of FIG. 3.

FIG. 6 is another timecard entry screen shot of the desktop application computer program of FIG. 3.

FIG. 7 is a change timesheet status screen shot of the desktop application computer program of FIG. 3.

FIG. 8 is an add employee screen shot of the desktop application computer program of FIG. 3.

FIG. 9 is an add activity screen shot of the desktop application computer program of FIG. 3.

FIG. 10 is an add equipment screen shot of the desktop application computer program of FIG. 3.

FIG. 11 is a progress quantity screen shot of the desktop application computer program of FIG. 3.

FIG. 12 is a planning screen shot of the desktop application computer program of FIG. 3.

FIG. 13 is a reports menu screen shot of the desktop application computer program of FIG. 3.

FIG. 14 is a progress recap screen shot of the desktop application computer program of FIG. 3.

FIG. 15 is an employee weekly recap screen shot of the desktop application computer program of FIG. 3.

FIG. 16 is an employee weekly recap by timekeeper screen shot of the desktop application computer program of FIG. 3.

FIG. 17 is an employee weekly by WBS screen shot of the desktop application computer program of FIG. 3.

FIG. 18 is an equipment weekly recap screen shot of the desktop application computer program of FIG. 3.

FIG. 19 is an equipment weekly cost detail screen shot of the desktop application computer program of FIG. 3.

FIG. 20 is a cost report screen shot of the desktop application computer program of FIG. 3.

FIG. 21 is a timekeeper daily report screen shot of the desktop application computer program of FIG. 3.

FIG. 22 is an employee signout report screen shot of the desktop application computer program of FIG. 3.

FIG. 23 is a project assignment report screen shot of the desktop application computer program of FIG. 3.

FIG. 24 is a screen rendering of a printable time card.

FIG. 25 is a maintenance screen shot of the desktop application computer program of FIG. 3.

FIG. 26 is an administration screen shot of the desktop application computer program of FIG. 3.

FIG. 27 is a user definitions screen shot of the desktop application computer program of FIG. 3.

FIG. 28 is an opening screen shot of a mobile application computer program for the work project system of FIG. 1.

FIG. 29 is a login screen shot of the mobile application computer program of FIG. 28.

FIG. 30 is a setup and configuration screen shot of the mobile application computer program of FIG. 28.

FIG. 31 is a current week screen shot of the mobile application computer program of FIG. 28.

FIG. 32 is a home screen shot of the mobile application computer program of FIG. 28.

FIG. 33 is a charge codes screen shot of the mobile application computer program of FIG. 28.

FIG. 34 is an allocations screen shot of the mobile application computer program of FIG. 28.

FIG. 35 is a select activity screen shot of the mobile application computer program of FIG. 28.

FIG. 36 is an element search screen shot of the mobile application computer program of FIG. 28.

FIG. 37 is an employee allocations grid screen shot of the mobile application computer program of FIG. 28.

FIG. 38 is an equipment allocations grid screen shot of the mobile application computer program of FIG. 28.

FIG. 39 is an employee allocation screen shot of the mobile application computer program of FIG. 28.

FIG. 40 is another employee allocation screen shot of the mobile application computer program of FIG. 28.

FIG. 41 is an equipment allocation screen shot of the mobile application computer program of FIG. 28.

FIG. 42 is another equipment allocation screen shot of the mobile application computer program of FIG. 28.

FIG. 43 is an element list screen shot of the mobile application computer program of FIG. 28.

FIG. 44 is a quantity allocation screen shot of the mobile application computer program of FIG. 28.

FIG. 45 is an employee hours worked and allocation screen of the mobile application computer program of FIG. 28.

FIG. 46 is another employee hours worked and allocation screen of the mobile application computer program of FIG. 28.

FIG. 47 is an employee signout screen shot of the mobile application computer program of FIG. 28.

FIG. 48 is an equipment signout screen shot of the mobile application computer program of FIG. 28.

FIG. 49 is another equipment signout screen shot of the mobile application computer program of FIG. 28.

FIG. 50 is a daily log screen shot of the mobile application computer program of FIG. 28.

FIG. 51 is a timekeeper view daily cost by day screen shot of the mobile application computer program of FIG. 28.

FIG. 52 is another timekeeper view daily cost by day screen shot of the mobile application computer program of FIG. 28.

FIG. 53 is yet another timekeeper view daily cost by day screen shot of the mobile application computer program of FIG. 28.

FIG. 54 is an engineer view daily cost by day screen shot of the mobile application computer program of FIG. 28.

FIG. 55 is another engineer view daily cost by day screen shot of the mobile application computer program of FIG. 28.

FIG. 56 is yet another engineer view daily cost by day screen shot of the mobile application computer program of FIG. 28.

FIG. 57 is a submit screen shot of the mobile application computer program of FIG. 28.

FIG. 58 is another submit screen shot of the mobile application computer program of FIG. 28.

FIG. 59 is yet another submit screen shot of the mobile application computer program of FIG. 28.

FIG. 60 is a user definitions screen shot of the mobile application computer program of FIG. 28.

FIG. 61 is an icon definitions screen shot of the mobile application computer program of FIG. 28.

### ABBREVIATIONS

As used herein, the following abbreviations should be understood to have the indicated meanings:

CATS: Cross Application Time Sheets, which is an SAP™ time sheet for entering labor time into SAP™ ERP software (available from SAP SE, Walldorf, Germany) directly. If ERP software other than SAP′ is used, similar time sheets or other labor entry means may be used.

ECC: Enterprise Central Component. An example of ECC software is that available from SAP SE (Walldorf, Germany).

ERP: Enterprise Resource Planning. An example of ERP software is that available from SAP SE (Walldorf, Germany).

ESB: Enterprise Service Bus, which is middleware that allows for a central place for various data sources to come into and go out of.

PBE: Performance Based Equipment, which provides a way to calculate “rent” for equipment based on performance, e.g., equipment used for 2 hrs. @ $50/hr.=$100 rent.

PF: Performance Factor, which is a ratio of actual hours and/or dollars to earned hours and/or dollars. PF=1 means that work is being performed on budget; PF<1 means that work is being performed under budget; and PF>1 means that work is being performed over budget.

WBS: Work Breakdown Structure, which is a unique cost code scheme.

ZEHOURS: a table in ERP/Mobile database where equipment run times (hours) entered by end users are stored.

ZMETERS: a table in ERP/Mobile database where equipment run time readings from electronic meters mounted on equipment are stored.

### Definitions

As used herein, the following terms should be understood to have the indicated meanings:

When an item is introduced by “a” or “an,” it should be understood to mean one or more of that item.

“Allocation” is the process of assigning the total labor hours actually worked, equipment hours actually used, and work progress quantities actually completed into one or more charge codes (e.g., WBS, activity, and/or element). For example, in a 10 hour work day, if half the day was spent working on charge code 1 and the other half was spent on charge code 2, allocation may involve assigning one-half of the associated actual labor hours, equipment hours, and work progress quantities to each of the two charge codes. In some embodiments, work progress quantities may or may not be the same, even though time worked was the same. For example, the work progress could be 100 units for the first 5 hours, but 125 units for the second 5 hours.

“Budget” means a target cost and quantity of resources (labor, equipment, materials, etc.) assigned to a work project or an activity of a work project to complete a specified amount of work. Such target costs and quantities may be expressed in units of time (e.g., work hours), value (e.g., dollars), units of work (e.g., square feet (SF)), value per unit time (e.g., dollars/hour), unit of work per unit time (e.g., SF/hour), or other suitable units. A budget may be associated with a specified timeframe (e.g., day, week, month, year, the entire work project duration, or the like). On a work project, the budgets typically are set up and locked in at the beginning of the project and may be changed only through a change order process.

“Communication” means the transmission of one or more signals from one point to another point. Communication between two objects may be direct, or it may be indirect through one or more intermediate objects. Communication in and among computers, I/O devices and network devices may be accomplished using a variety of protocols. Protocols may include, for example, signaling, error detection and correction, data formatting and address mapping. For example, protocols may be provided according to the seven-layer Open Systems Interconnection model (OSI model), the TCP/IP model, or any other suitable model.

“Comprises” means includes but is not limited to.

“Comprising” means including but not limited to.

“Computer” means any programmable machine capable of executing machine-readable instructions. A computer may include but is not limited to a general purpose computer, mainframe computer, microprocessor, computer server, digital signal processor, personal computer (PC), personal digital assistant (PDA), laptop computer, desktop computer, notebook computer, smartphone (such as Apple's iPhone™, Motorola's Atrix™ 4G, and Research In Motion's Blackberry™ devices, for example), tablet computer, netbook computer, portable computer, portable media player with network communication capabilities (such as Microsoft's Zune HD™ and Apple's iPod Touch™ devices, for example), camera with network communication capability, wearable computer, point of sale device, or a combination thereof. A computer may comprise one or more processors, which may comprise part of a single machine or multiple machines.

“Computer readable medium” means an article of manufacture having a capacity for storing one or more computer programs, one or more pieces of data, or a combination thereof. A computer readable medium may include but is not limited to a computer memory, hard disk, memory stick, magnetic tape, floppy disk, optical disk (such as a CD or DVD), zip drive, or combination thereof.

“Earned Value” means the amount of budget (e.g., cost and/or quantity of resources, such as time or materials, for example) that should have been spent in order to accomplish an actual amount of work completed. Earned Value may be calculated based on percent complete, which may be determined as a ratio of actual quantity to budgeted quantity. For example, if a given activity was budgeted to take 10 hours to complete 100 units of work, but the work crew was able to complete the 100 units of work in only 8 hours, then the percent complete would be 100% (100 units actual/100 units budgeted), the Earned Value for that activity would be 10 hours (100% of the budget), and the PF for that activity would be 0.8 (8 hours actual/10 hours earned). Similarly, if a given activity was budgeted to take 10 hours to complete 100 units of work, but the work crew was able to complete only 80 units of work in 10 hours, then the percent complete would be 80% (80 units actual/100 units budgeted), the Earned Value for that activity would be 8 hours (80% of the budget), and the PF for that activity would be 1.25 (10 hours actual/8 hours earned).

“GUI” means graphical user interface.

“Having” means including but not limited to.

“Interface” means a portion of a computer processing system that serves as a point of interaction between or among two or more other components. An interface may be embodied in hardware, software, firmware, or a combination thereof.

“I/O device” may comprise any hardware that can be used to provide information to and/or receive information from a computer. Exemplary I/O devices may include disk drives, keyboards, video display screens, mouse pointers, joysticks, trackballs, printers, card readers, scanners (such as barcode, fingerprint, iris, QR code, and other types of scanners), RFID devices, tape drives, touch screens, cameras, movement sensors, network cards, storage devices, microphones, audio speakers, styli and transducers, and associated interfaces and drivers.

“Laborer” means a person who performs work. A laborer may be an employee or an independent contractor. A laborer may or may not be a timekeeper as defined herein.

“Memory” may comprise any computer readable medium in which information can be temporarily or permanently stored and retrieved. Examples of memory include various types of RAM and ROM, such as SRAM, DRAM, Z-RAM, flash, optical disks, magnetic tape, punch cards, EEPROM, and combinations thereof. Memory may be virtualized, and may be provided in or across one or more devices and/or geographic locations, such as RAID technology, for example.

“Module” means a portion of a program.

“Network” may comprise a cellular network, the Internet, intranet, local area network (LAN), wide area network (WAN), Metropolitan Area Network (MAN), other types of area networks, cable television network, satellite network, telephone network, public networks, private networks, wired or wireless networks, virtual, switched, routed, fully connected, and any combination and subnetwork thereof. A network may use a variety of network devices, such as routers, bridges, switches, hubs, repeaters, converters, receivers, proxies, firewalls, translators and the like. Network connections may be wired or wireless, and may use multiplexers, network interface cards, modems, ISDN terminal adapters, line drivers, and the like. A network may comprise any suitable topology, such as point-to-point, bus, star, tree, mesh, ring, and any combination or hybrid thereof.

“Plan” means a target cost and quantity of labor and/or equipment to be used on a work project or an activity of a work project. Such target costs and quantities may be expressed in units of time (e.g., work hours), value (e.g., dollars), units of work (e.g., square feet (SF)), value per unit time (e.g., dollars/hour), unit of work per unit time (e.g., SF/hour), or other suitable units. A plan may include specific personnel and equipment designated for performing the work of an activity or project. A plan may be associated with a specified timeframe (e.g., day, week, month, year, the entire work project duration, or the like). In comparison of budgets and plans, budgets generally are more static as they are typically locked in at the beginning of a work project and changed only pursuant to authorized change orders, whereas plans generally are more dynamic and may be created and changed independent of the budget throughout the specified timeframe.

“Program” may comprise any sequence of instructions, such as an algorithm, for example, whether in a form that can be executed by a computer (object code), in a form that can be read by humans (source code), or otherwise. A program may comprise or call one or more data structures and variables. A program may be embodied in hardware, software, firmware, or a combination thereof. A program may be created using any suitable programming language, such as C, C++, Java, Perl, PHP, Ruby, SQL, other languages, and combinations thereof. Computer software may comprise one or more programs and related data. Examples of computer software may include system software (such as operating system software, device drivers and utilities), middleware (such as web servers, data access software and enterprise messaging software), application software (such as databases, video games and media players), firmware (such as software installed on calculators, keyboards and mobile phones), and programming tools (such as debuggers, compilers and text editors).

“Real-time” means a substantially simultaneous timeframe in which a computer system's activities substantially match the human perception of time.

“Signal” means a detectable physical phenomenon that is capable of conveying information. A signal may include but is not limited to an electrical signal, an electromagnetic signal, an optical signal, an acoustic signal, or a combination thereof.

“Timekeeper” means a person who is responsible for reporting time for one or more laborers, which may or may not include such person. For example, a foreman may be a timekeeper for his or her crew (including labor and equipment), and possibly also for himself or herself.

“Work Project Data” means data pertaining to a work project, such as charge codes, budgets, quantity takeoffs, unit rates, and the like.

### DETAILED DESCRIPTION

As described herein, computerized systems and methods are provided for planning, executing, and evaluating labor, equipment, and work progress quantities used on various work projects, such as construction projects, for example. Such systems and methods may provide a unique integrated solution which implements business processes electronically in a central database application and a mobile application. Such systems and methods may provide real-time, accurate information related to job costs in one convenient location for access by personnel in an organization's offices and in the field (e.g., at job sites).

For example, systems and methods described herein may enable users to:

1. Plan daily work (e.g., via the desktop application zDTC described herein), which may include:
a. Assignment of labor and equipment to a foreman.
b. Assignment of charge codes (e.g., WBS, activity, and/or element) specific to the day.
c. Assignment of budgets, man hours, target work quantities, and daily production goals.
d. Carrying out of “what if” scenarios to optimize job cost based on either budgeted unit cost and/or past performance unit cost, and the ability to compare actuals to either the budget or the plan.
e. Pushing the plan to individual mobile devices.

2. Capture daily information (e.g., via the mobile application zMTC or the desktop application zDTC described herein), which may include:
f. Ability to capture worked labor hours and also not worked hours, such as holidays, jury duty, sick leave, personal and vacation time, by each person.
g. Ability to sign electronically on the mobile devices and answer questions related to safety and other questions as required. Examples may include “were you injured today?”, “did you get all your prescribed breaks today”, or the like.
h. Capture of employee signature along with hours worked and automatic date, time and GPS location stamp.
i. Ability to capture equipment hours by each piece of equipment. Electronic meter readings may be fed into the mobile app from 3^{rd} party web services, for example, to assist the foreman in determining equipment run time.
j. Ability to capture progress quantities of work done by charge code (e.g., WBS, activity, and/or element).
k. Ability to allocate labor hours, equipment hours, and work progress quantities to charge codes (e.g., WBS, activity, and/or element).
l. Ability to log daily reports.
m. Ability to view trade certifications by employee on the mobile app.

3. Review daily or weekly cost and performance data (e.g., via the mobile application zMTC or the desktop application zDTC described herein), which may include:
n. Review of the performance of the crew on the device, in real-time, once hours and quantity allocations are entered. This may allow the foreman to see on the device in real-time where the crew performed better than, equal to, or worse than the budget and/or the plan.
o. Review of weekly performance as daily performance is stored for the foreman to review any time within a given period (e.g., a rolling 2-week period or other suitable period).

4. Accumulate all daily capture information (e.g., via the desktop application zDTC described herein), which may include:
p. Review and approval of all the various foremen's and their crews' times and progressed quantities.
q. Validation of the information and data with the central database (e.g., SAP ECC or other ERP software).
r. Uploading of labor time into the central database (e.g., SAP ECC or other ERP software) for payroll processing.
s. Uploading of equipment run time into the central database (e.g., SAP ECC or other ERP software) for equipment rent processing.
t. Uploading of progress quantities into the central database (e.g., SAP ECC or other ERP software) for earned value calculations.

5. Run various reports to help improve accuracy of reporting and calculating job cost.

6. Maintain laborer, equipment, and work progress photos, videos, and other records.

As persons of ordinary skill in the art will appreciate, systems and methods as described herein may provide more accurate and timely capture of labor and equipment usage data and may enable work project managers to make real-time labor and equipment adjustments in order to improve job performance on current jobs. Additionally, systems and methods as described herein may enable work project managers to make more accurate labor and equipment estimates for future jobs.

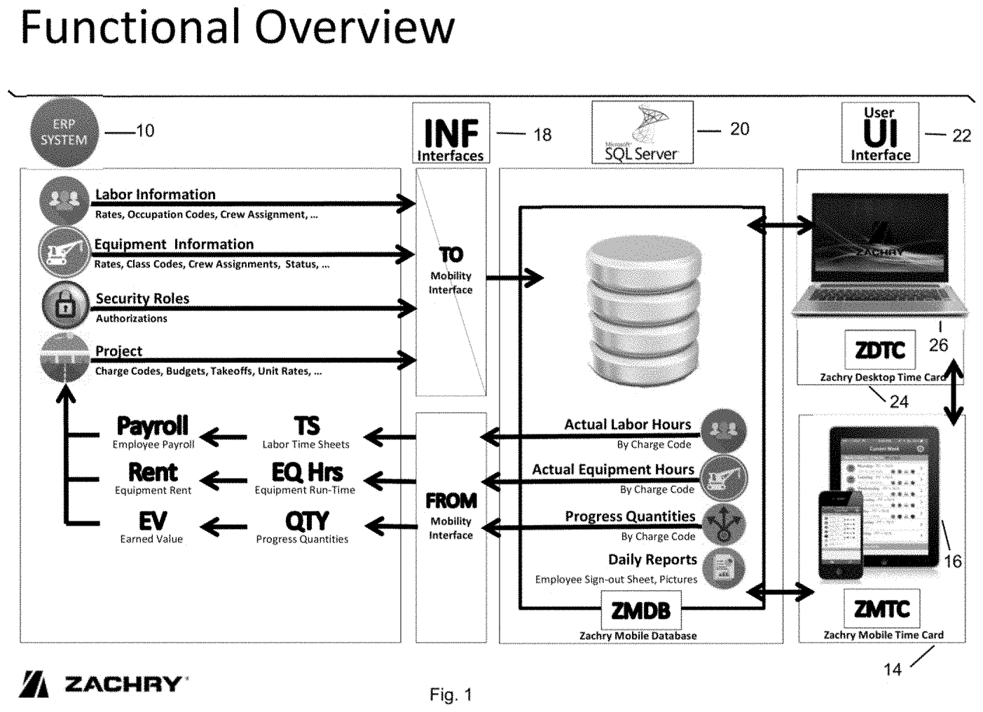

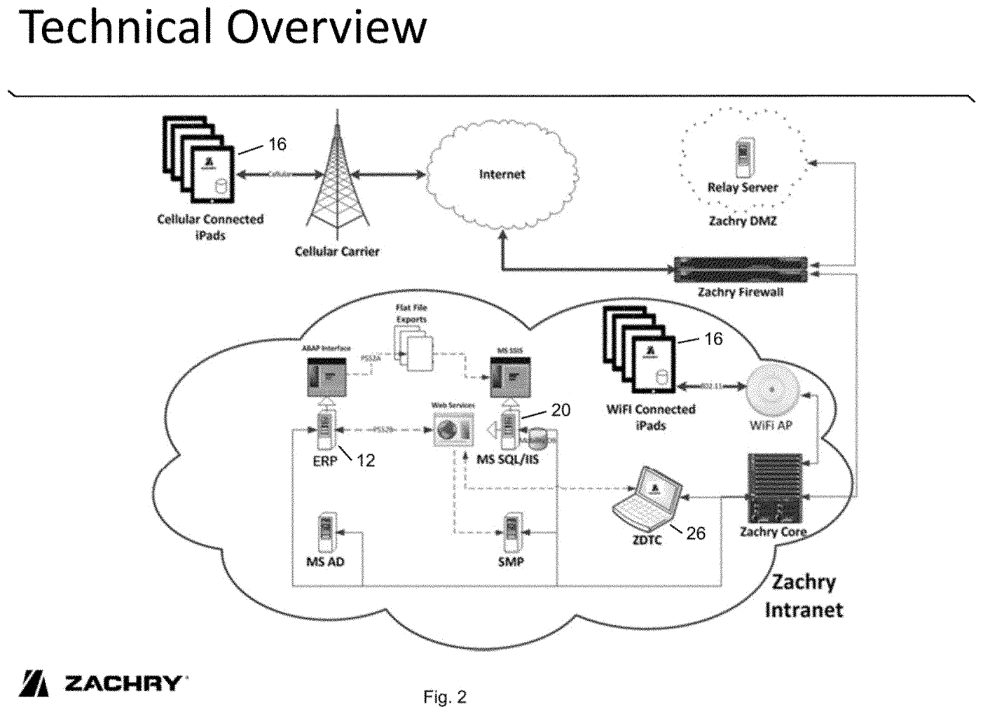

As shown in FIGS. 1-2, a system and method for planning and capturing labor and equipment usage in real-time for work projects, such as construction projects, for example, may include a database application 10, such as SAP ECC or other ERP software, for example, configured to execute on a central server computer 12 and a mobile application 14 (sometimes referred to herein as ZMTC) configured to execute on mobile client computers 16, such as smartphones or tablets, for example. A file server may provide one or more interfaces 18 for communication between the central server computer 12 and the mobile client computers 16. In some embodiments, mobility source data may be communicated between the mobile client computers 16 and the central server computer 12 via a mobility source data server 20, such as a SQL™ server available from Microsoft Corporation, for example. The database application 10 may include data regarding laborers, equipment, timekeeper assignments, projects, user roles, maintenance orders, payroll, CATS, progress quantities, equipment PBE documents, ZEHOURS, and ZMETERS, for example. Equipment run time meter readings (e.g., via XacTrac™ software available from Guardian Global Technologies, Inc.) and equipment fuel usage readings (e.g., via OEM devices) may be communicated into the database application 10 directly or via an ESB, for example. The mobile devices 16 may be used to enter labor hours, work quantities, and equipment hours, which may be transmitted to the database application 10 by suitable communication means (e.g., wireless network transmission). Additionally, various data from the central database application 10, such as data regarding laborers, equipment, timekeeper assignments, projects, user roles, maintenance orders, and ZMETERS, for example, may be provided to the mobile devices 16 for viewing. With access to such data, users may also use the mobile devices 16 to view various reports, such as labor recap, equipment recap, weekly cost, timekeepers' daily, and employee sign-out reports, for example. In some embodiments, users may also use the mobile devices 16 with a web browser to review daily planning and desktop time entry, and to conduct review and approval of certain data entries made by other personnel. Access to certain data and reports may be controlled via appropriate user credentials. The system and method may also include a desktop application 24 (sometimes referred to herein as ZDTC, which is described further below) configured to execute on desktop or laptop client computers 26 (which may also be mobile). Mobile application 14 and desktop application 24 may serve as user interfaces 22 for transferring data between the central server computer 12 and the mobile client computers 16 and desktop/laptop client computers 26. Persons of ordinary skill in the art will appreciate that the communication between the central computer 12 and the mobile computers 16 and desktop/laptop computers 26 and equipment may be by any suitable means, such as wired or wireless network transmission (e.g., cellular or Internet).

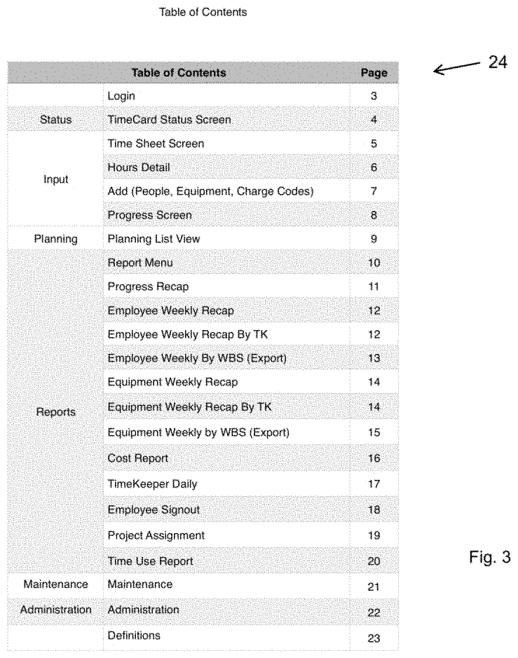

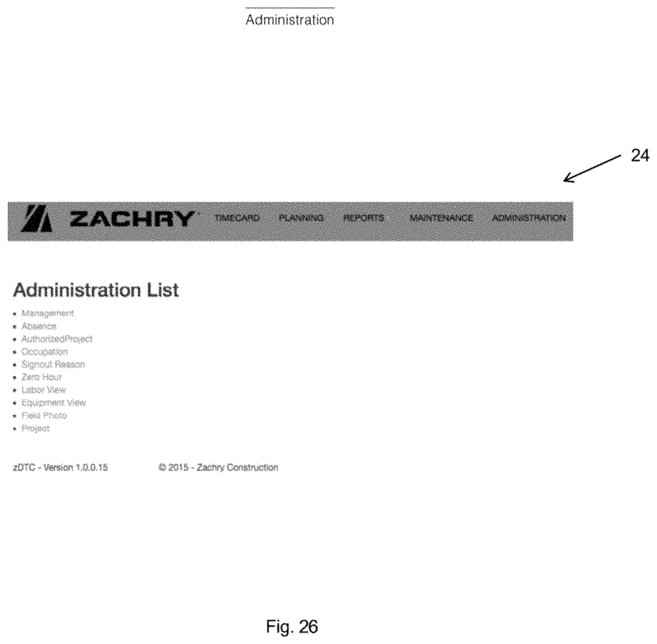

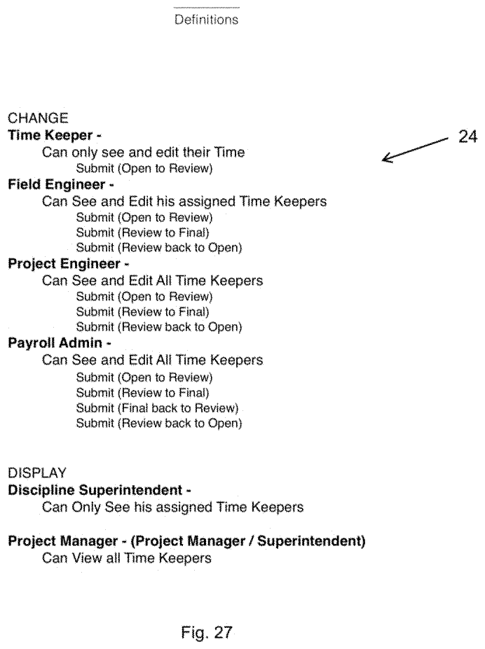

As shown in FIGS. 3-27, desktop application 24 (ZDTC) may be configured to enable project management personnel to create and modify work plans, to capture time worked by the relevant personnel, to capture run times of equipment assigned to each work project, and to capture work progress quantities of completed work. Labor and equipment time may be recorded for each laborer and piece of equipment, respectively, for each element of each activity of each project on a daily basis, and the progress toward completion of actuals with respect to the budget or the plan may be tracked and viewed.

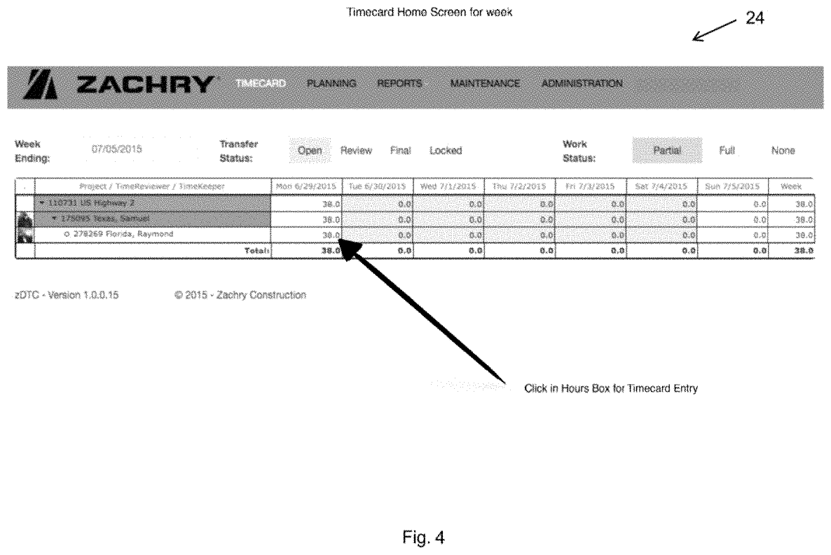

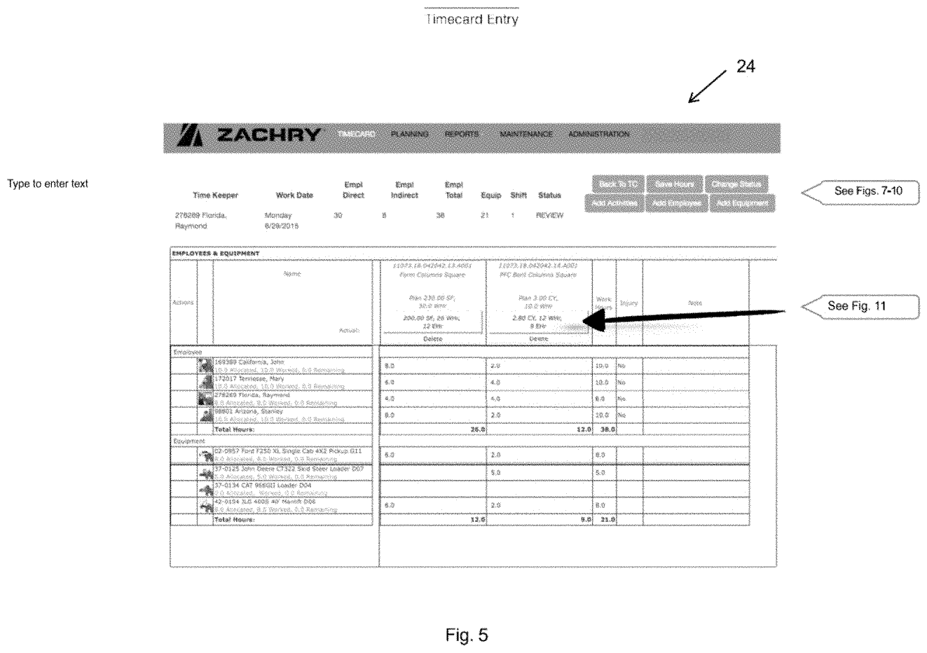

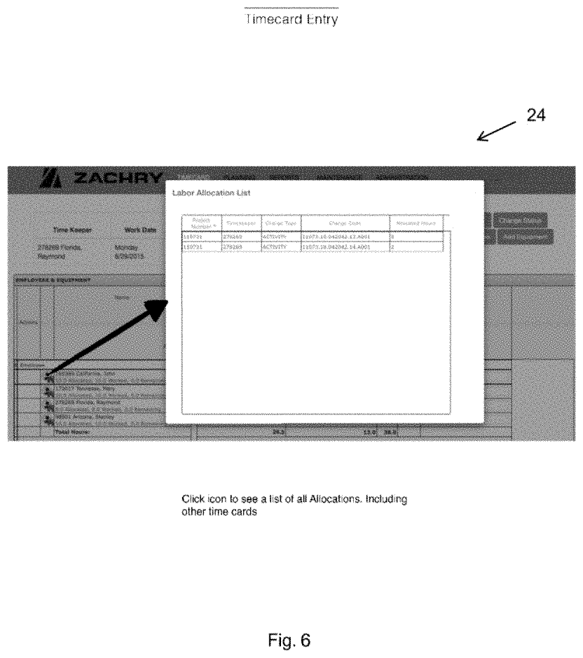

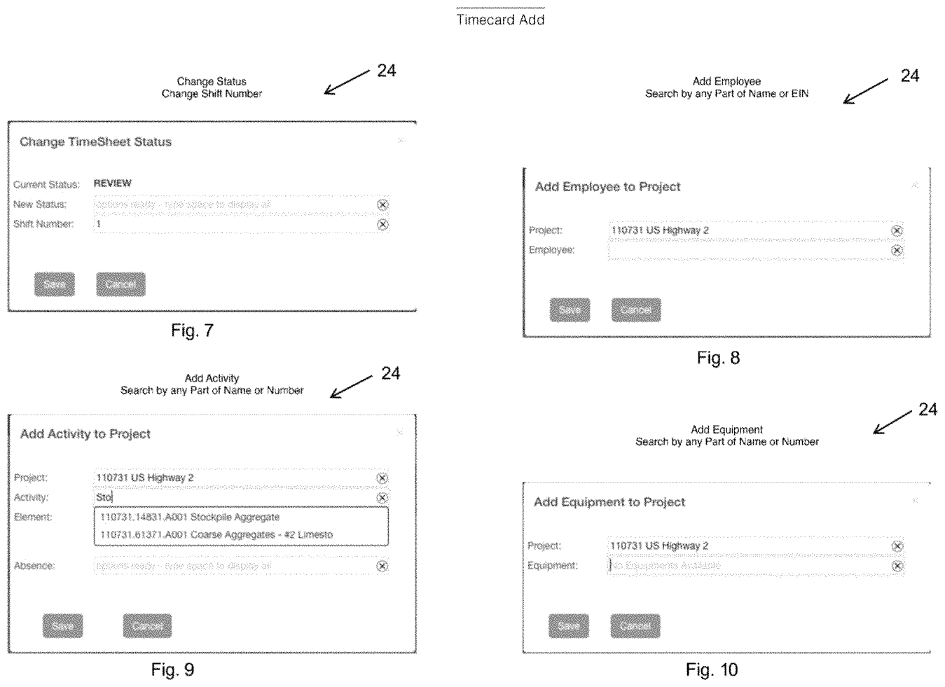

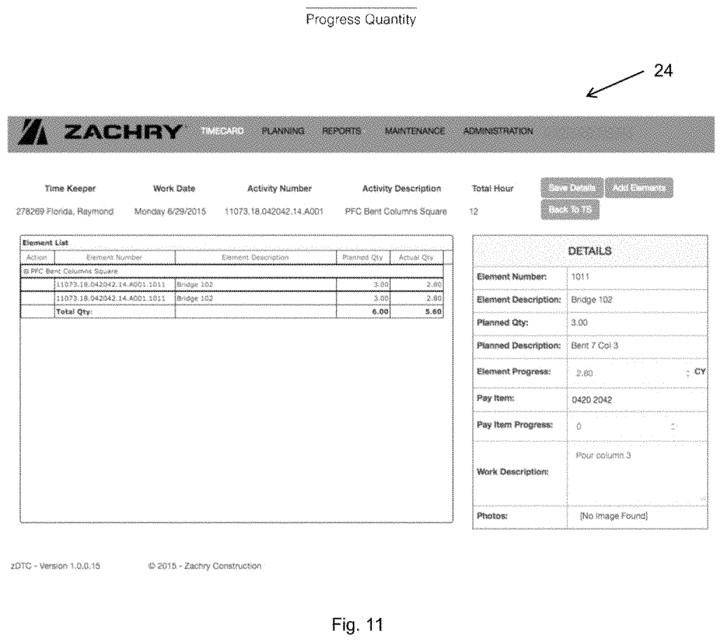

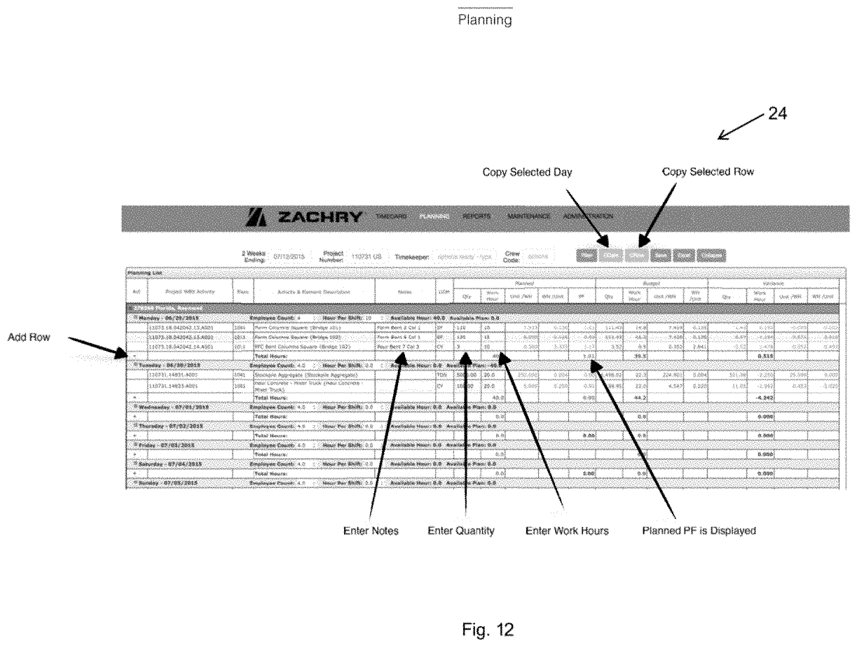

For example, as shown in FIG. 3, ZDTC 24 may include timecard status, input, planning, reports, maintenance, and administration functions. As shown in FIG. 4, users may enter, view, and approve time entries on a project, reviewer, and timekeeper basis for any selected time period. As shown in FIG. 5, users may enter, view, and approve labor and equipment time entries for all personnel and equipment assigned to a specified timekeeper on each of a plurality of tasks on any specified date. As shown in FIG. 6, users may allocate labor hours worked and equipment runtime hours to whichever project and task is appropriate. As shown in FIG. 7, users may change the status and shift number associated with a selected timesheet. As shown in FIGS. 8, 9, and 10, respectively, users may add one or more employees, activities, and equipment to a selected project. As shown in FIG. 11, users may enter, view, and approve actual and planned work progress quantities for each activity of a work project for each timekeeper. As shown in FIG. 12, for any selected work project and timekeeper, users may plan labor and equipment time and work quantities for each activity for each day, and users may enter notes as appropriate. To help facilitate such plans, a user may copy a selected day or a selected row to use for similar activities or days. As work progresses, users may view the progress of the actual work completed against the budget and the plan, and they may adjust future plans as needed in order to accomplish desired objectives in view of the work progress information.

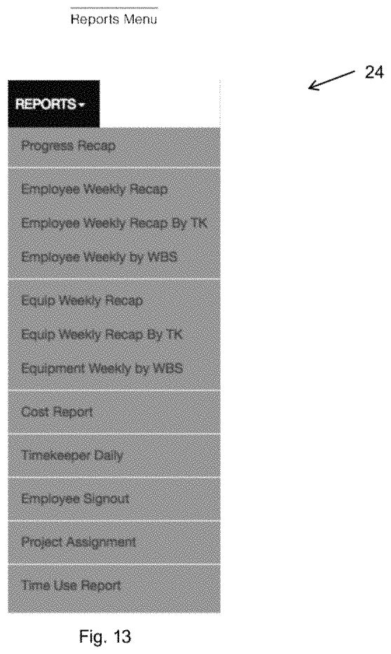

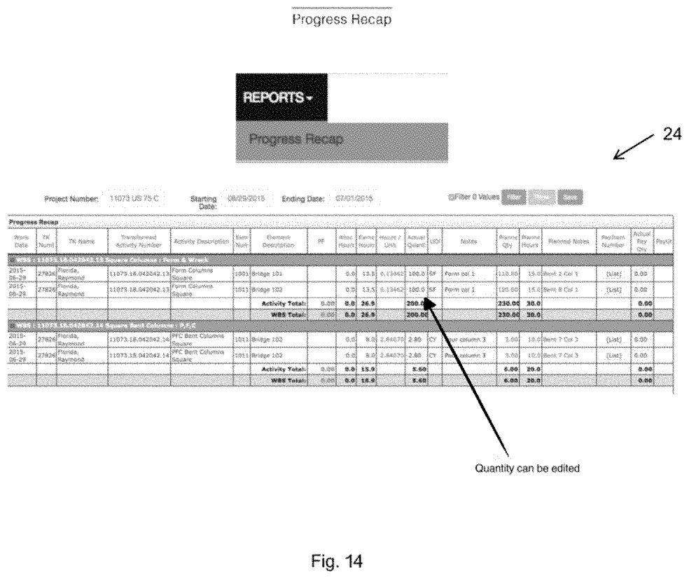

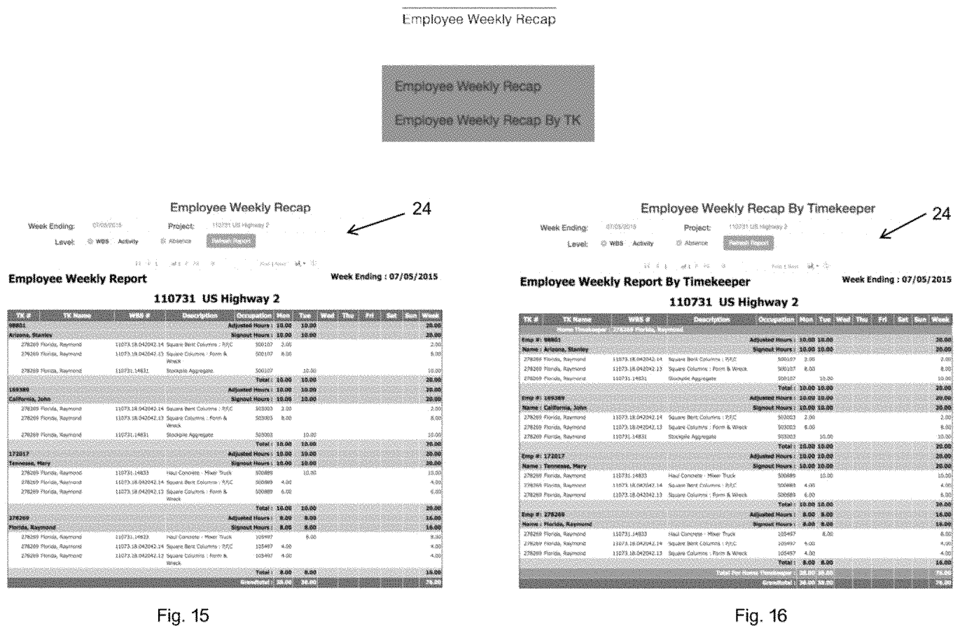

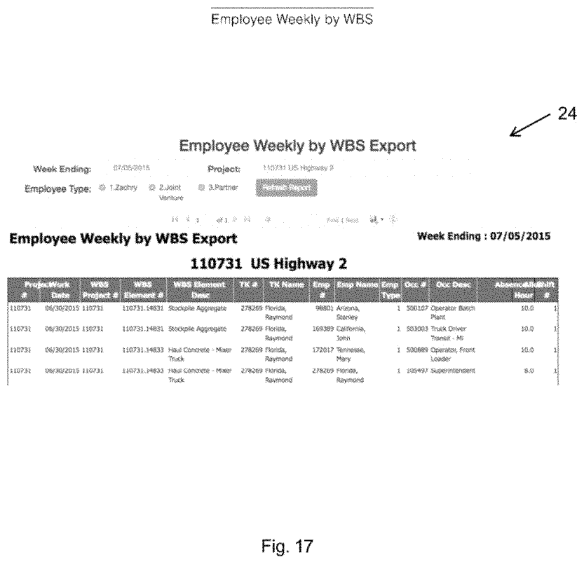

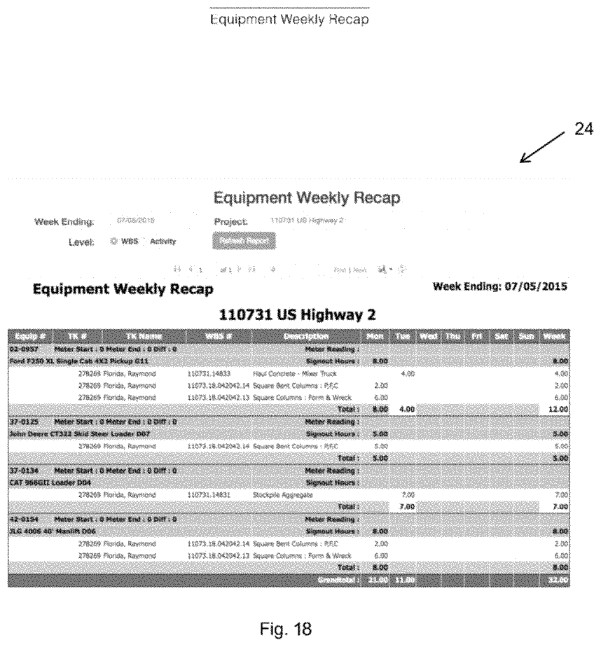

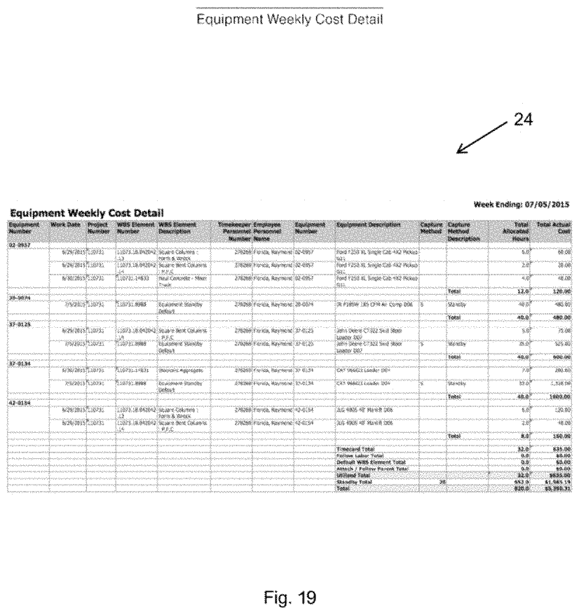

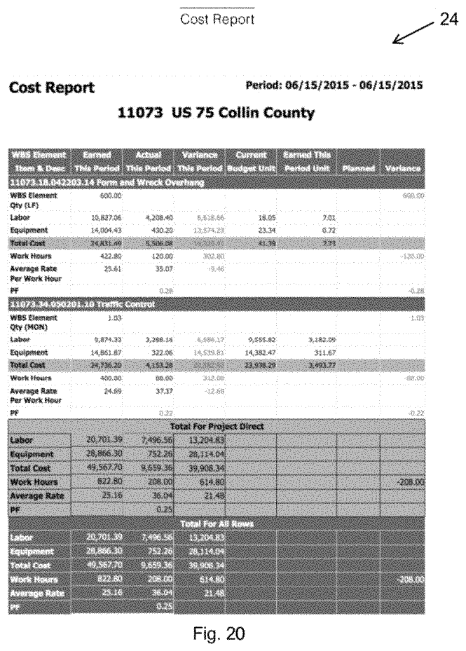

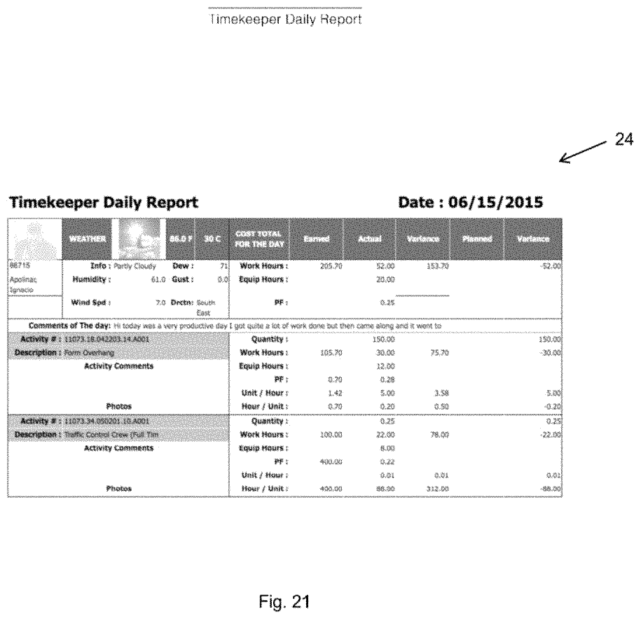

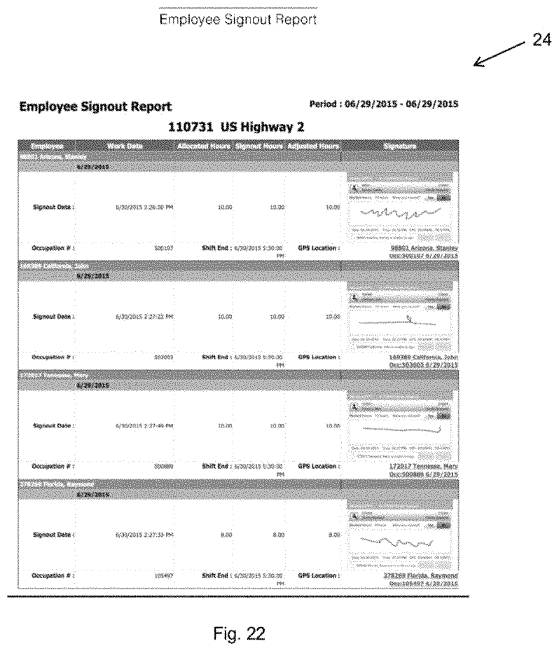

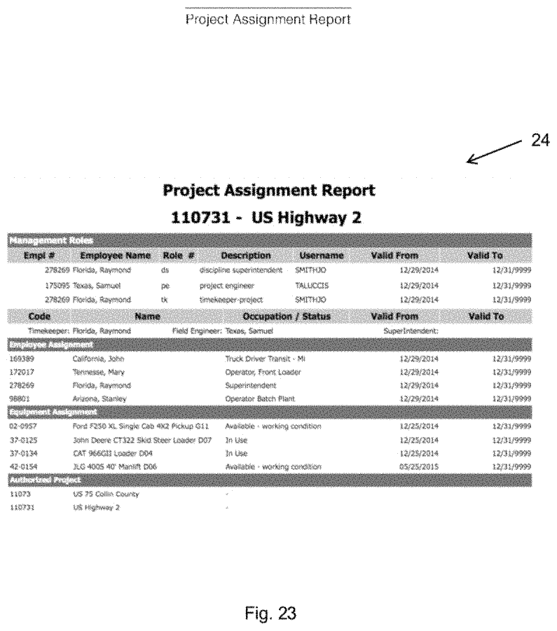

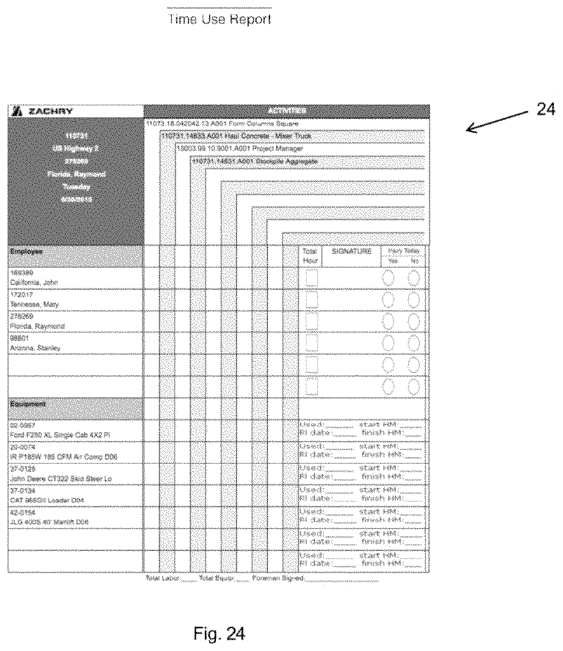

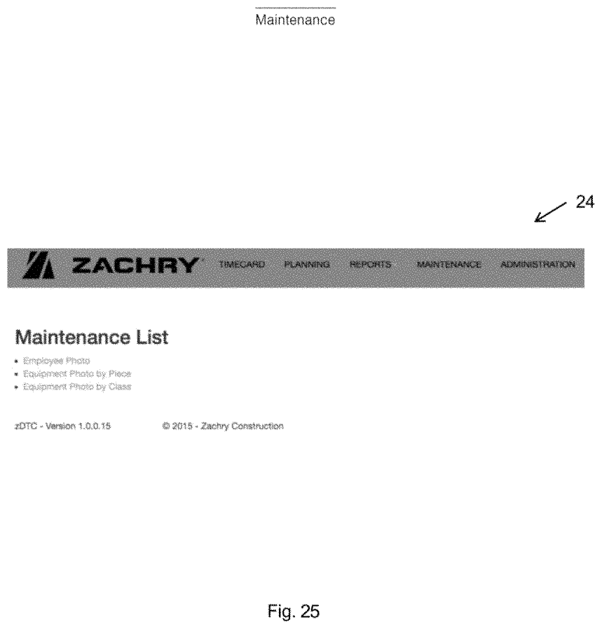

As shown in FIG. 13, ZDTC 24 may include a reports menu that enables a user to select any of a number of available reports concerning work projects, such as progress recap, employee weekly recap by timekeeper or WBS, equipment weekly recap by timekeeper or WBS, costs, timekeeper daily, employee signout, project assignment, and time use reports, for example. For example, a sample progress recap report is shown in FIG. 14, a sample employee weekly recap report is shown in FIG. 15, a sample employee weekly recap by timekeeper report is shown in FIG. 16, a sample employee weekly by WBS report is shown in FIG. 17, a sample equipment weekly recap report is shown in FIG. 18, a sample equipment weekly cost detail report is shown in FIG. 19, a sample cost report is shown in FIG. 20, a sample timekeeper daily report is shown in FIG. 21, a sample employee signout report is shown in FIG. 22, a sample project assignment report is shown in FIG. 23, and a sample time use report is shown in FIG. 24. Sample maintenance, administration, and user definitions screens are shown in FIGS. 25, 26, and 27, respectively. Of course, any suitable user credentials and restrictions may be established for each type of user.

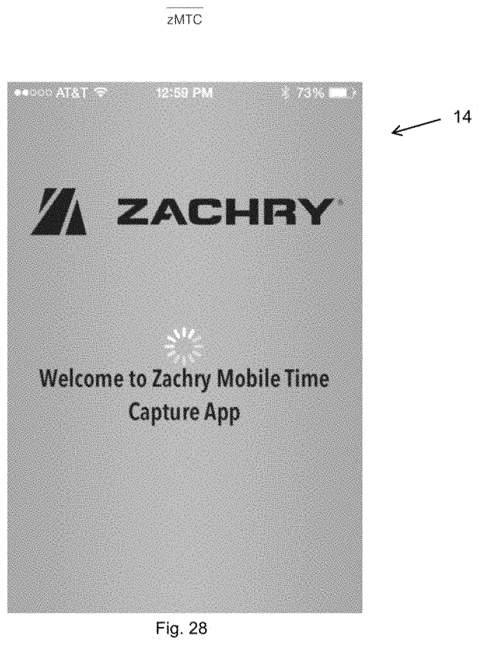

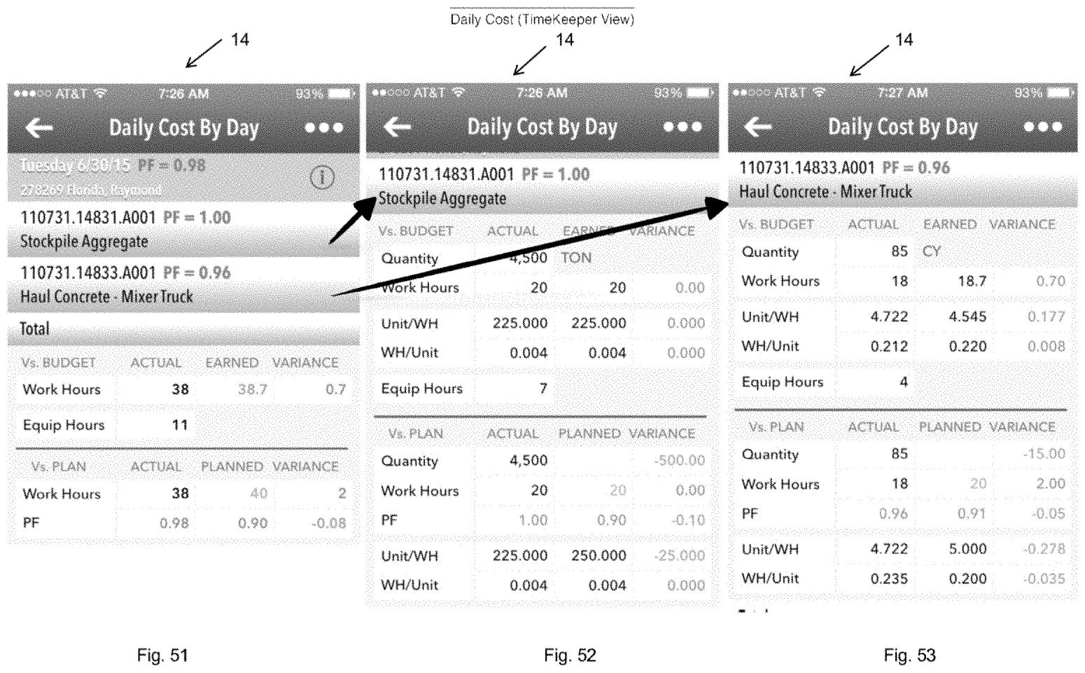

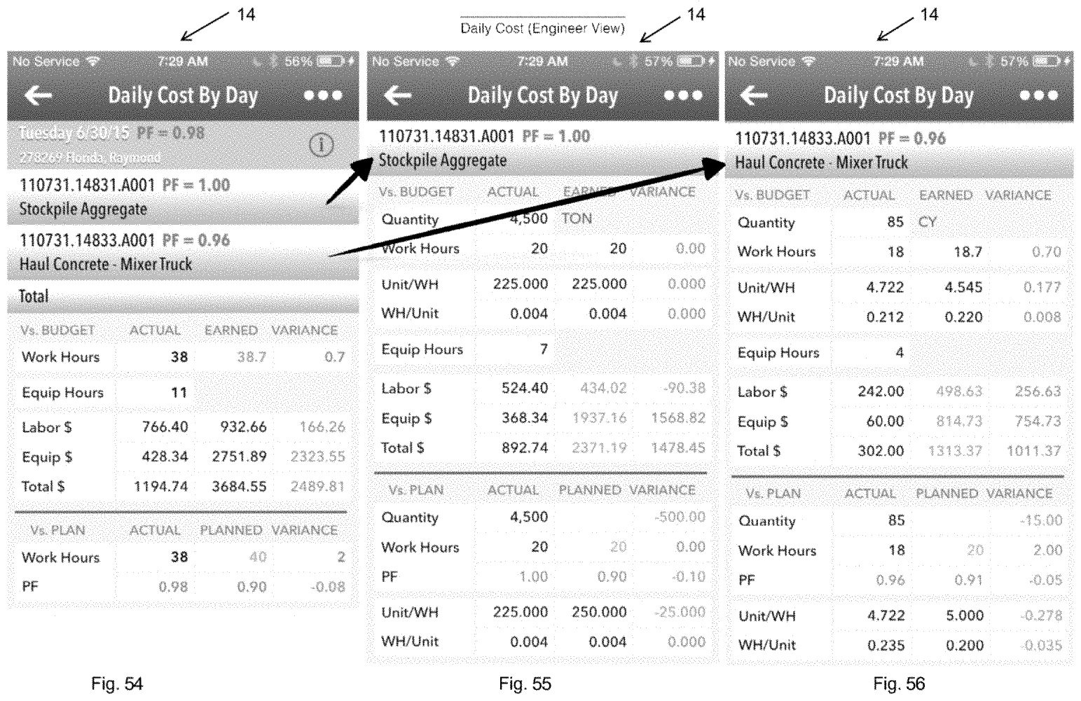

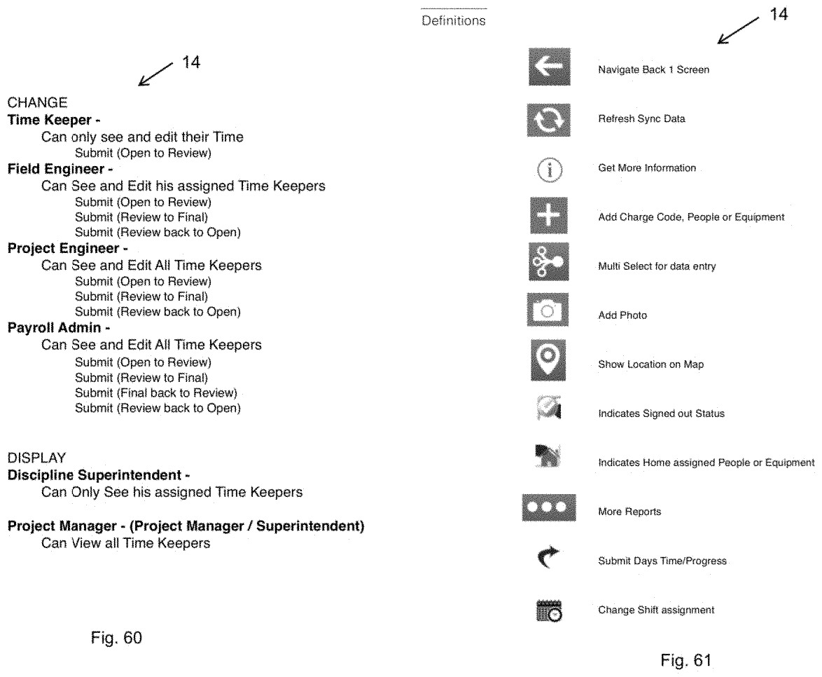

As shown in FIGS. 28-61, mobile application 14 (ZMTC) may be configured to enable timekeepers to enter, review, and submit time worked by laborers on a project remotely from their smartphones or other mobile devices 16 on a daily basis. Supervisory personnel with the appropriate credentials may also review, edit, and submit the time entries made by the various timekeepers under their supervision, as shown in FIG. 60, for example. The mobile application 14 may include labor and equipment allocations, whereby each activity may be assigned a certain number of hours worked by certain laborers and a certain number of run time hours for each piece of equipment used for that activity. As work is performed each day, the actual time spent and quantity of work accomplished by each laborer and piece of equipment on each activity may be recorded via the mobile application and communicated to the central server computer 12, and the actual amounts may be compared to the corresponding budget and plan in real-time. As illustrated in FIGS. 51-53, a performance factor PF of actual to budget or actual to plan may be calculated to indicate the performance of each laborer or timekeeper (e.g., foreman of a work crew) with respect to the budget or the plan for each activity and overall across all activities. Such labor or timekeeper performance factors may be calculated on the basis of time worked, or quantity of work accomplished (e.g., square feet of flooring installed, linear feet of fencing installed, miles of roadway paved, or the like), or other suitable metric. Similarly, equipment performance factors may be calculated on the basis of run time, quantity of work accomplished, or other suitable metric. The results of all laborers or timekeepers on a project may also be combined in order to show overall performance on a given day, week, or other time period on the project, or for a given activity within a project. The recorded labor and equipment hours may be multiplied by the applicable labor and equipment cost rates, respectively, available in the database application 10 in order to calculate the actual labor and equipment costs for each laborer, timekeeper, and equipment for each activity each day, which may be displayed for appropriately credentialed personnel as shown in FIGS. 54-56. Such labor and equipment performance and cost information may be displayed on the mobile client computers 16 as numerical values, graphical indications (e.g., bar graphs, pie graphs, or the like), or other suitable indications.

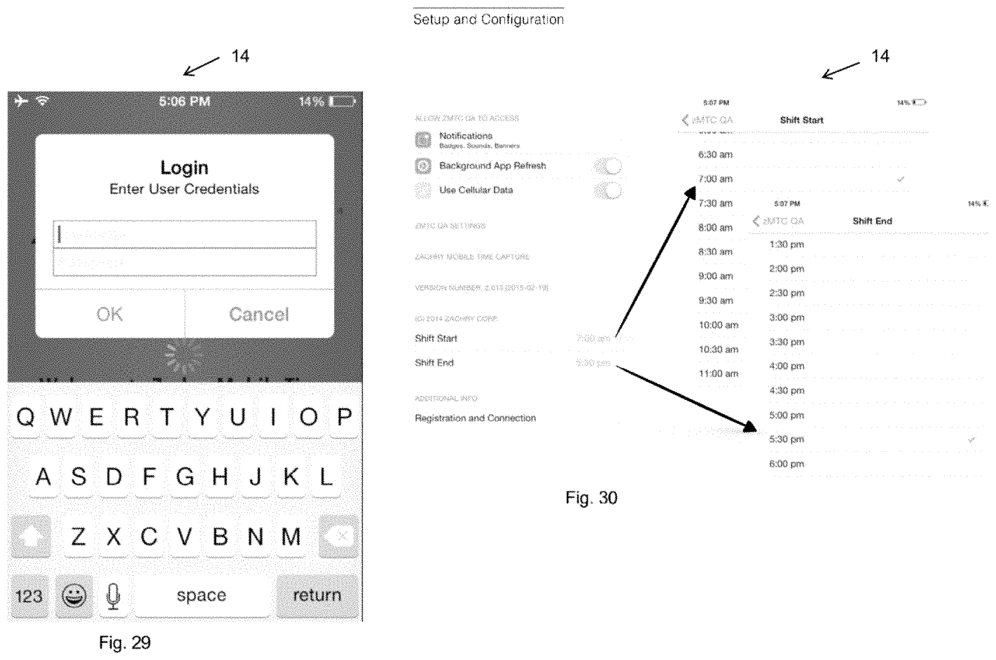

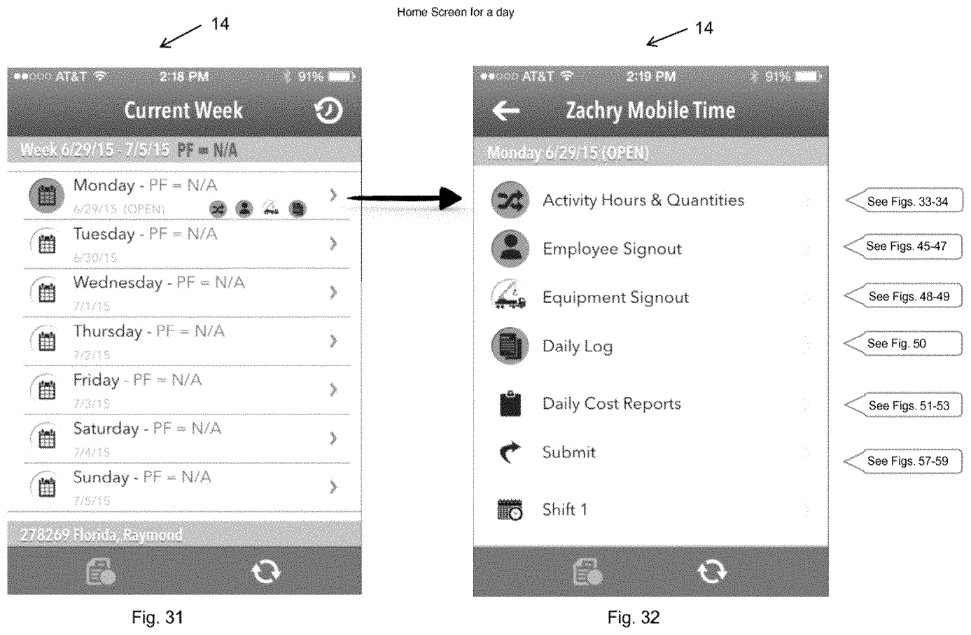

In some embodiments, as shown in FIG. 29, mobile application 14 may have a login screen at which a properly credentialed user may log in. Once logged in, a user may select shift start and end times as shown in FIG. 30 and may access a current week display screen as shown in FIG. 31 and a home screen as shown in FIG. 32, for example. The home screen may allow a user to navigate to various other functional screens, such as activity hours and quantities, employee signout, equipment signout, daily log, daily cost reports, and submit screens, for example.

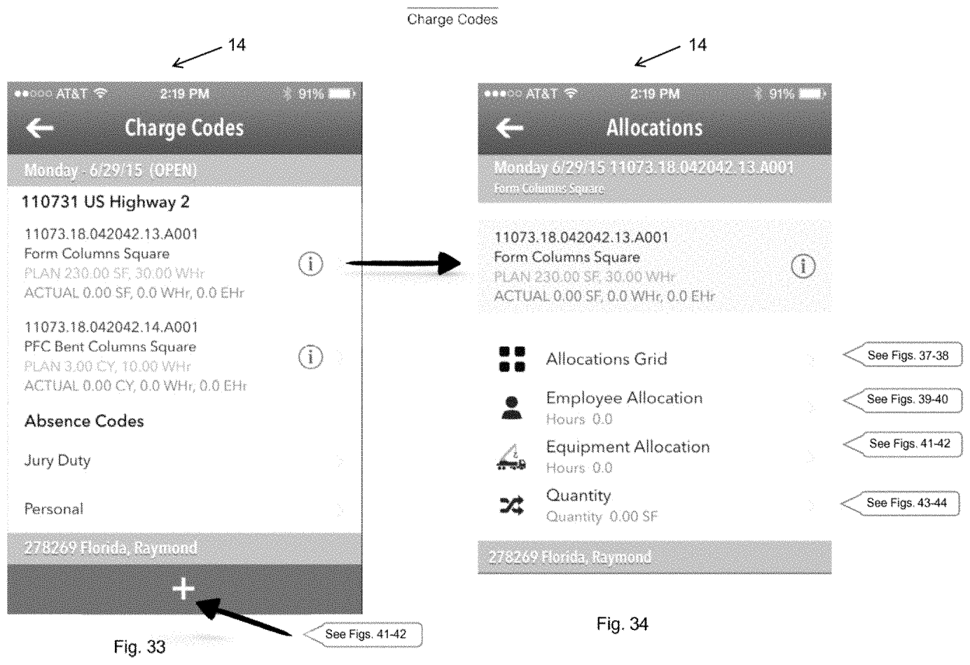

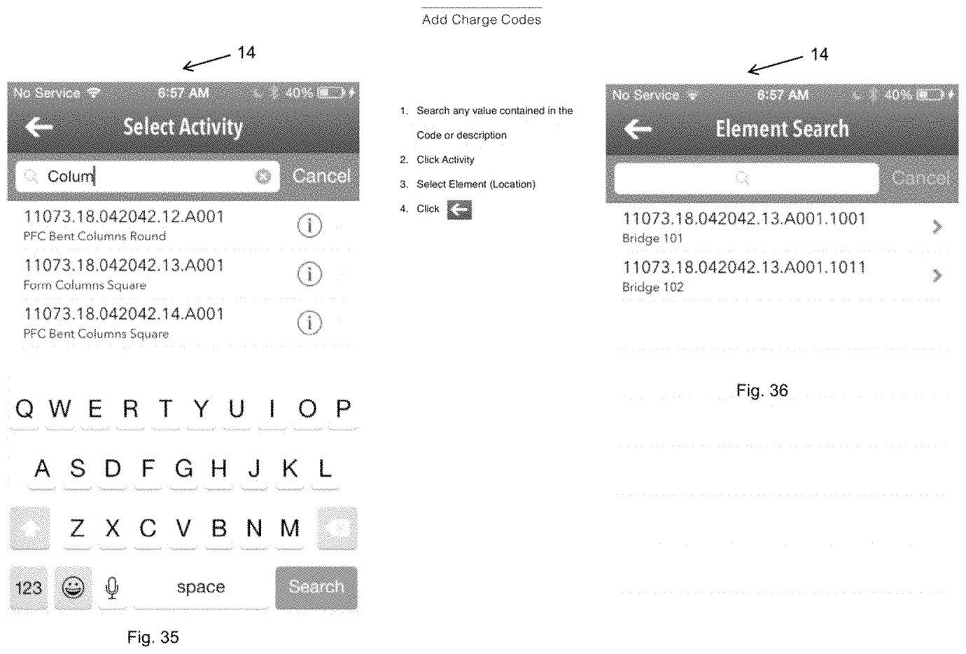

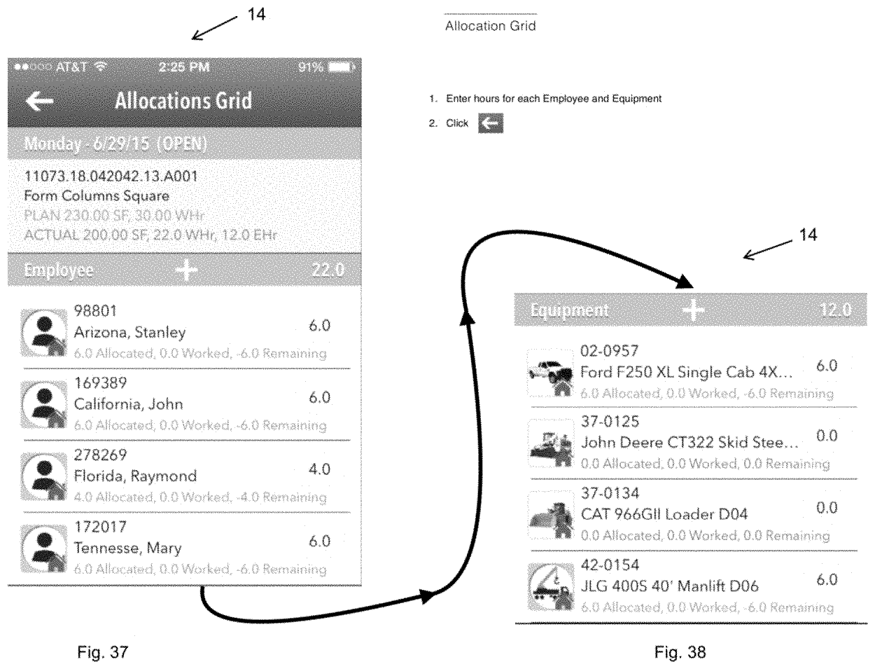

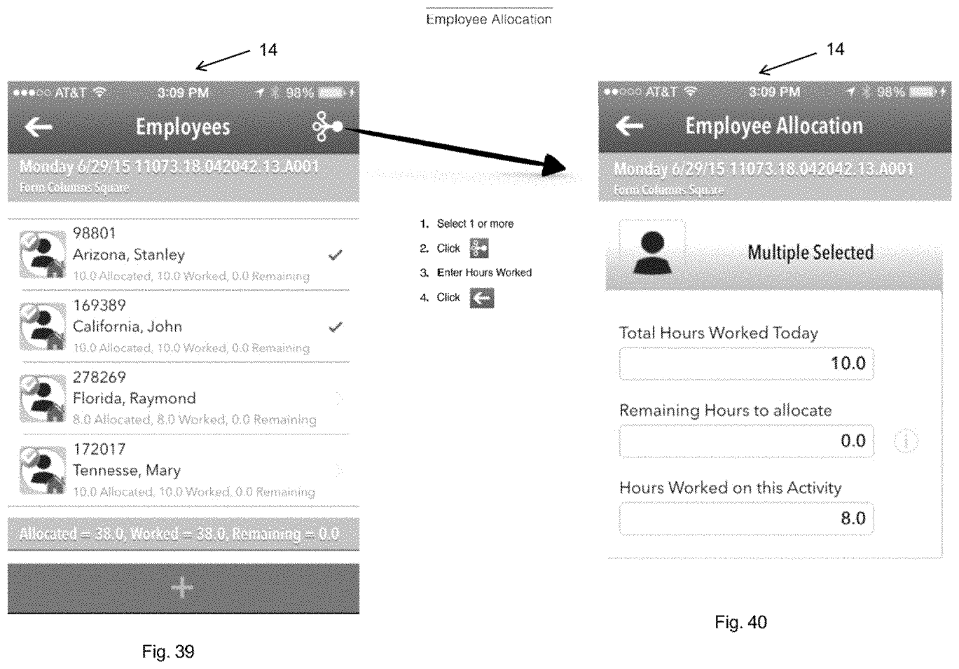

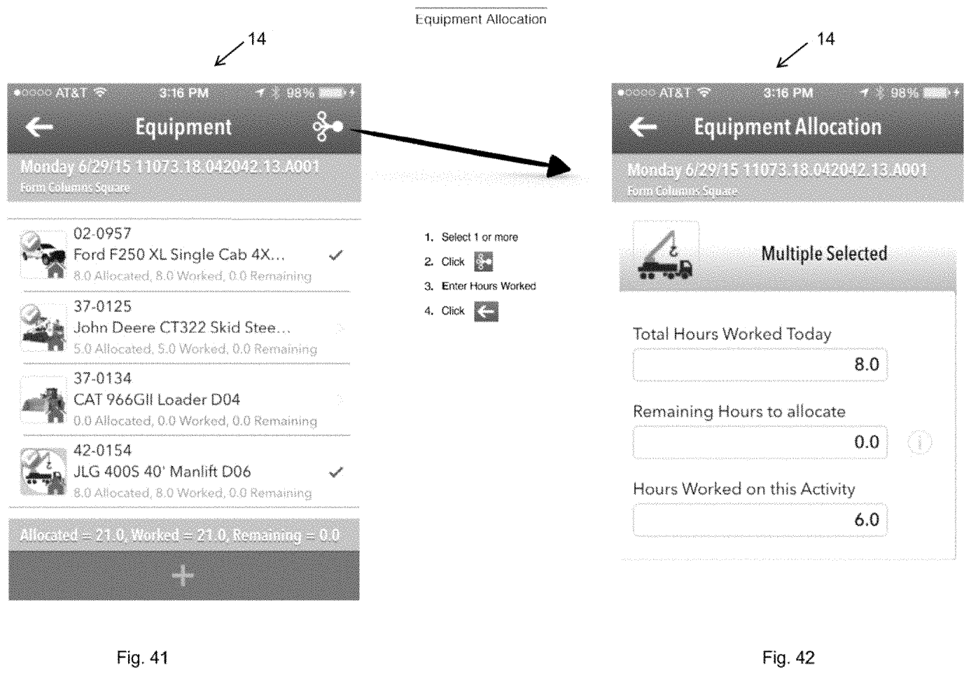

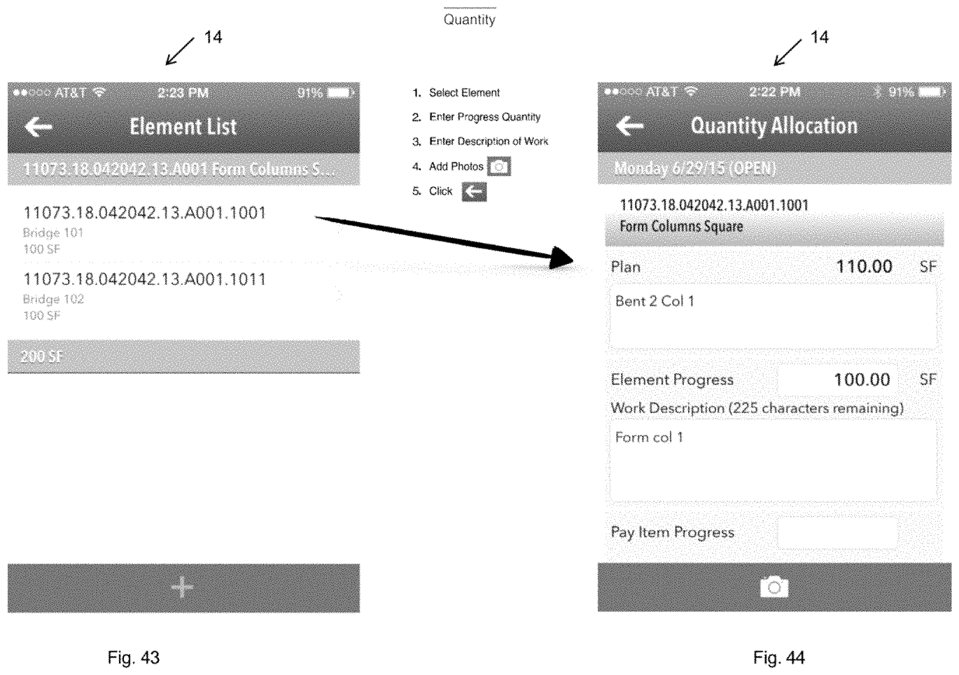

As shown in FIG. 33, a charge code screen of mobile application 14 may allow a user to view and select one or more work activities for which labor and equipment allocations may be made, showing planned and actual hours worked and work progress units for each activity. Referring also to FIG. 34, an allocations screen may allow a user to select an allocations grid, employee allocation, equipment allocation, or work quantity for a selected work activity. As shown in FIGS. 35 and 36, work activity and element screens may allow a user to search for and select any desired work activity or element for which labor or equipment time should be allocated. If “allocations grid” is selected in FIG. 34, allocations grid screens as shown in FIGS. 37-38 may allow a user to view and select one or more laborers (e.g., employees) and one or more pieces of equipment for which time allocations may be made, showing time allocated, worked, and remaining for each laborer and piece of equipment associated with a selected work activity. If “employee allocation” is selected in FIG. 34, employee and employee allocation screens may be provided as shown in FIGS. 39-40, thereby allowing a user to view and select appropriate laborers (e.g., employees), view how much time was worked and allocated and remaining for each laborer, and enter the appropriate number of hours worked by those laborers for a selected activity to be allocated to a selected charge code. If “equipment allocation” is selected in FIG. 34, equipment allocation screens as shown in FIGS. 41 and 42 may allow a user to view and select one or more pieces of equipment used on a work activity, view how much time was worked and allocated and remaining for each piece of equipment, and allocate any remaining time to an applicable charge code for a selected activity. If “quantity” is selected in FIG. 34, element list and quantity allocation screens as shown in FIGS. 43 and 44 may allow a user to view and select one or more work elements and enter the appropriate work quantity completed for each element, showing both planned and actual work progress quantities.

The mobile application 14 may also include laborer and equipment signout procedures. For example, in some embodiments, the laborer signout procedure may include questions pertaining to employee safety and break compliance. The capture of such employee safety and break compliance data may help an employer defend against fraudulent claims of injury and failure to provide adequate breaks. The system may also capture GPS location from each mobile device 16 at the time of signout, which may serve as a check on whether an employee or piece of equipment is actually at the proper work site. The system may also record the local weather conditions each day at each job site, which may serve as evidence of whether certain events may have been affected by the weather (e.g., job progress inhibited by adverse weather conditions), or whether certain claims made by personnel are likely to be substantiated in view of the local weather conditions at the job site on a given date.

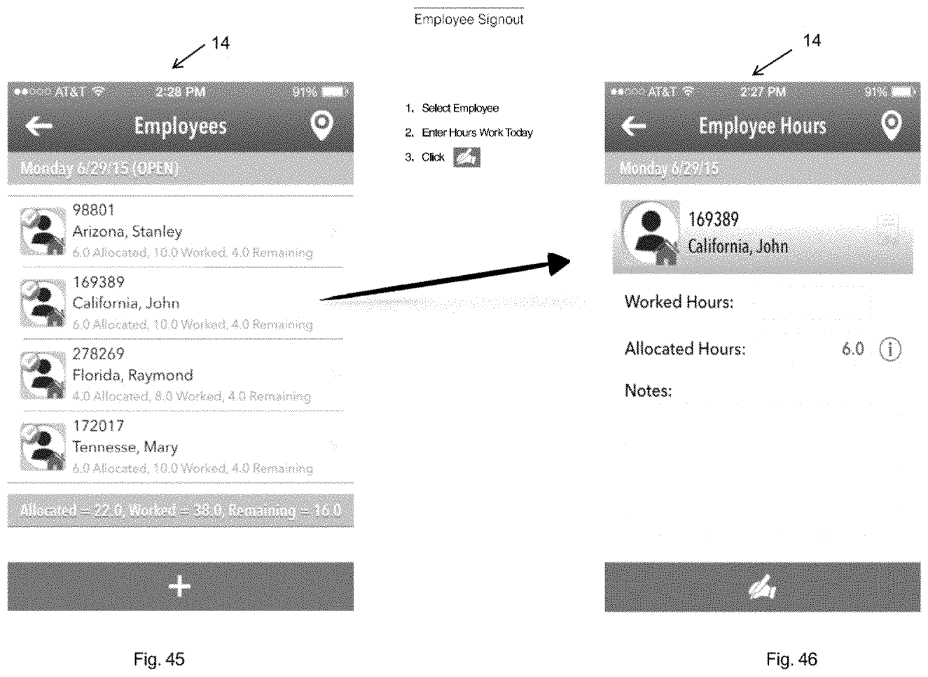

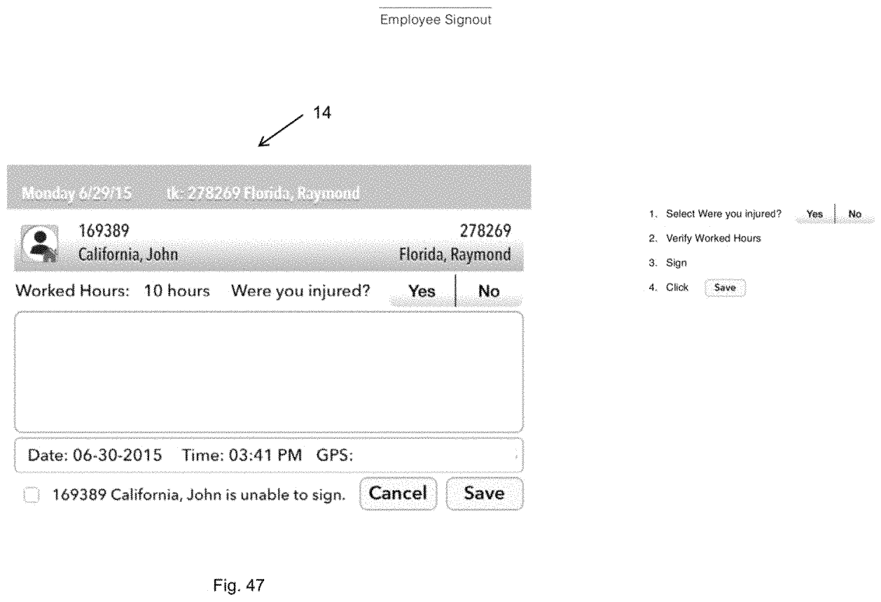

For example, as shown in FIG. 45, mobile application 14 may have an employee (laborer) screen at which a user may select a certain laborer from among a list of laborers. The screen may show the allocated, worked, and remaining hours for each laborer. Once a laborer is selected, mobile application 14 may then provide an employee hours screen as shown in FIG. 46, thereby allowing a user to enter the hours worked for the selected laborer. Once the time worked is entered, the user may select a “signature” icon, which may cause an employee signout screen to be presented as shown in FIG. 47. The user may verify the number of worked hours for the particular day and indicate whether he or she was injured that day and sign out.

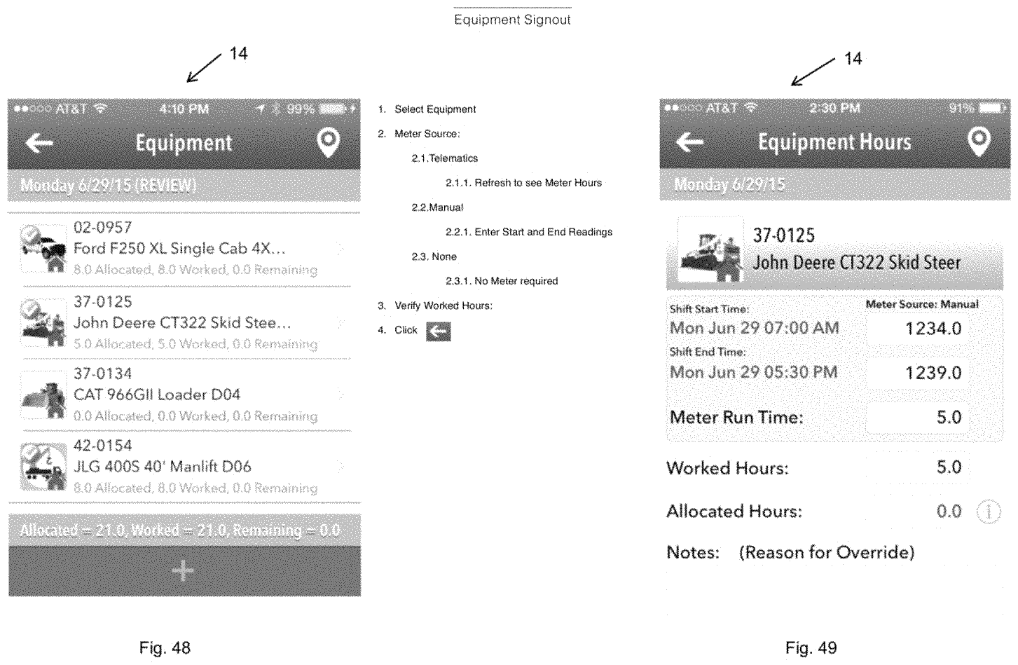

In some embodiments, mobile application 14 may include an equipment signout screen as shown in FIG. 48 at which a user may view and select one or more pieces of equipment associated with a selected work activity, showing time allocated, worked, and remaining for each piece of equipment. For a selected piece of equipment, mobile application 14 may include an equipment hours screen as shown in FIG. 49 at which a user may enter or verify applicable run time. In some embodiments, equipment run time may be automatically recorded by run time meters on the equipment and transmitted to mobile application 14 via wireless communication. In some embodiments, equipment run time may be entered manually, and in some embodiments a user may override an automatic run time entry with a manual run time entry and enter a reason for the override.

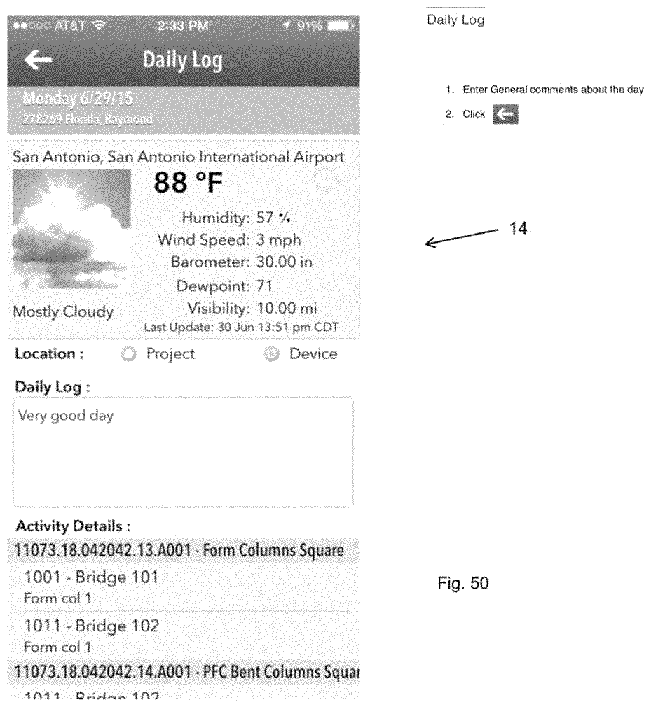

In some embodiments, mobile application 14 may include a daily log screen as shown in FIG. 50. The daily log screen may include a list of the work activities accomplished on that day and may allow a user to enter comments as well. The daily log screen may also indicate the weather conditions for that day at a particular work site and/or a location associated with the user's mobile device.

In some embodiments, mobile application 14 may include daily cost by day screens viewable by timekeepers as shown in FIGS. 51-53. For a selected day, a timekeeper may view his or her work crew's performance versus the applicable work plan and/or versus the applicable budget on an overall basis and for each work activity. The screens may indicate actual and earned labor and equipment hours and work progress quantities and the associated variance versus the applicable budget and/or the applicable plan.

In some embodiments, mobile application 14 may also include daily cost by day screens viewable by engineers or other higher credentialed personnel as shown in FIGS. 54-56. These screens may be similar to those viewable by timekeepers or other lower credentialed personnel as shown in FIGS. 51-53, except that the screens for the engineers or other higher credentialed personnel may also show the dollar values associated with the labor and equipment time data. Additionally, an engineer user or other higher credentialed personnel may view such data for any timekeeper or work crew assigned to such engineer, for example. Sample user credentials are shown in FIG. 60, although any suitable user credentials may be used, as desired.

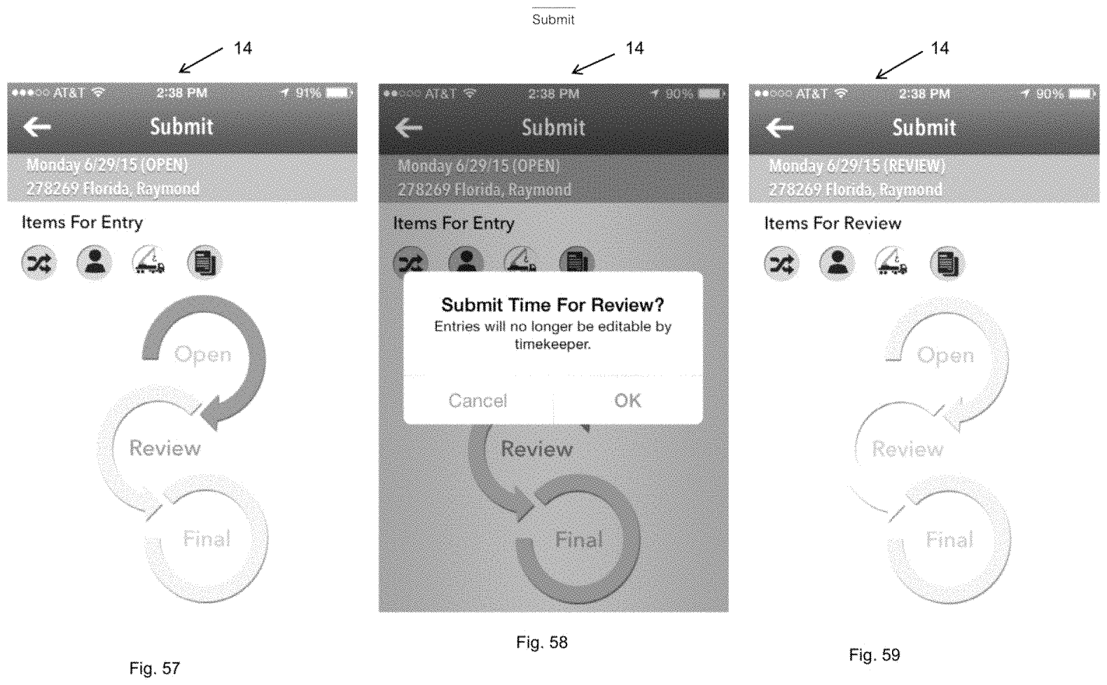

In some embodiments, mobile application 14 may also include submit screens as shown in FIGS. 57-59. Properly credentialed users may enter, review, and submit labor and equipment time entries as described herein. Exemplary icons and associated definitions for mobile application 14 are illustrated in FIG. 61.

Persons of ordinary skill in the art will appreciate that systems and methods as described herein are extremely useful for providing up-to-date performance information regarding actual labor and equipment time and costs compared to budgeted or planned time and costs for various work projects. Such performance information may be provided at the laborer level, timekeeper level, work crew level, activity level, and/or overall project level. By providing such information to work project managers in real-time, they may readily determine whether work is progressing as expected and may make adjustments to the work plans as needed in order to achieve better work efficiencies. This is helpful not only with regard to current projects, but it also may greatly improve planning and budgeting for future projects.

It should be understood that one or more computers may be configured with proper programming on one or more computer readable media to perform the actions described herein. Each such computer may have one or more processors, memories, GUIs, interfaces, I/O devices, and communication devices. Although some actions are described as being performed on a central computer and other actions are described as being performed on a mobile computer, it should be understood that any action may be performed on any such computer. For example, in some embodiments, the mobile client computers may be “thin” clients, with most of the processing being done on one or more central computers. In other embodiments, a significant amount of processing may be performed on the mobile client computers. Persons of ordinary skill in the art will appreciate that the hardware, software, and database structure may be tailored to meet any desired applications.

The embodiments described above are some examples of the current invention. Various modifications and changes of the current invention will be apparent to persons of ordinary skill in the art. Among other things, any feature described for one embodiment may be used in any other embodiment, and methods described and shown in the figures may be combined. In addition, the order of steps shown in the figures and described above may be changed in different embodiments. The scope of the invention is defined by the appended claims and other claims that may be drawn to this invention, considering the doctrine of equivalents, and is not limited to the specific examples described herein.

What is claimed is:

1-18. (canceled)

19. A work project system for planning at least daily use of equipment in a work project and for characterization of equipment performance over time in the work project, the system comprising a computer having a tangible computer readable medium with program instructions executable by the computer, the instructions being configured for:
providing to at least one mobile client computer, at least once daily, one or more charge codes associated with one or more work activities included in a daily plan for the work project and identification of one or more pieces of equipment included in the daily plan and available for use on the work project;
receiving from the at least one mobile client computer a selection of a charge code among the one or more charge codes, the selected charge code being associated with a selected work activity among the one or more work activities, and a selection of a piece of equipment among the one or more pieces of equipment;
receiving run time data at least once daily for the selected piece of equipment, the run time data being automatically recorded by an electronic run time meter on the selected piece of equipment;
providing the run time data to the at least one mobile client computer at least once daily;
receiving from the at least one mobile client computer an allocation of the run time data to the selected work activity based on the selected charge code;
receiving from the at least one mobile client computer work progress data towards completion of the selected work activity;
computing an equipment earned value and an equipment variance for the selected piece of equipment with respect to each of the daily plan and a budget for the selected work activity using the run time data and the work progress data;
communicating the equipment earned value and the equipment variance for each of the daily plan and the budget to the at least one mobile client computer at least once daily in real-time following allocation of the run time data and the work progress data;
computing a plan performance factor for the selected piece of equipment with respect to the daily plan based on the work progress data, the allocation of the run time data, and a planned amount of daily work progress designated in the daily plan;
computing a budget performance factor for the selected piece of equipment with respect to the budget based on the work progress data, the allocation of the run time data, and a budgeted amount of work progress designated in the budget; and
communicating the plan performance factor and the budget performance factor to the at least one mobile client computer at least once daily in real-time following allocation of the run time data and the work progress data;
wherein the equipment earned values, the equipment variances, the plan performance factor, and the budget performance factor are communicated to the at least one mobile client computer in a manner that enables the at least one mobile client computer to display the equipment earned values, the equipment variances, the plan performance factor, and the budget performance factor to a user.

20. The work project system of claim 19 wherein:
the one or more charge codes comprises a plurality of charge codes associated with a respective plurality of work activities;
the one or more pieces of equipment comprises a plurality of pieces of equipment;
the system computes an equipment earned value, an equipment variance, a plan performance factor, and a budget performance factor for each of the plurality of pieces of equipment for each respective selected work activity; and
for each of the plurality of pieces of equipment associated with each respective selected work activity, the system communicates the equipment earned value, the equipment variance, the plan performance factor, and the budget performance factor to the at least one mobile client computer at least once daily in real-time following a respective allocation of run time data and work progress data.

21. The work project system of claim 19 wherein the instructions are further configured for:
allowing a user to modify the daily plan independent of the budget.

22. The work project system of claim 20 wherein the instructions are further configured for:
computing a cost associated with each of the plurality of pieces of equipment associated with each respective selected work activity; and
displaying the cost to an appropriately credentialed user.

23. The work project system of claim 22 wherein the instructions are further configured for:
allowing a user to carry out “what if” scenarios to optimize cost based on either budgeted unit cost or past performance unit cost associated with the plurality of pieces of equipment.

24. A work project system for evaluating the performance of equipment used in a work project, the system comprising a central computer and at least one mobile client computer each having a tangible computer readable medium with program instructions executable by a computer, the work project system being configured for:
receiving, at the central computer, run time data at least once daily for each of a plurality of equipment, the run time data being automatically recorded by an electronic run time meter on each of the plurality of equipment and communicated to the central computer;
storing the run time data in a run time database at the central computer;
providing the run time data from the central computer to the at least one mobile client computer at least once daily;
providing a plurality of charge codes associated with a respective plurality of work activities for the work project from the central computer to the at least one mobile client computer;
at the at least one mobile client computer, allocating the run time data to one or more of the plurality of work activities using the plurality of charge codes;
at the at least one mobile client computer, recording work progress data towards completion of the one or more of the plurality of work activities;
at the central computer, for each of the plurality of equipment, computing an equipment earned value and an equipment variance with respect to each of a budget and a plan for the one or more of the plurality of activities using the run time data; and
displaying the equipment earned value and the equipment variance for the plan on the at least one mobile client computer in real-time following allocation of the run time data.

25. The work project system of claim 24, the plurality of charge codes being provided to the at least one mobile client computer at least once daily as part of a daily work plan, the work project system being further configured for:
receiving a selection of a work activity among the plurality of work activities; and
in response to the selection, providing a listing of one or more pieces of equipment among the plurality of equipment designated for use on the selected work activity in the daily work plan.

26. The work project system of claim 25 being further configured for:
displaying a work quantity allocation screen, the work quantity allocation screen displaying an amount of work progress designated in the daily work plan for a selected work activity, the work progress designated for the daily work plan being displayed in quantitative units suitable for characterizing work progress for the selected work activity;
the work quantity allocation screen providing for input of actual work progress in the same quantitative units as displayed in the daily work plan.

27. The work project system of claim 24, the plurality of charge codes being provided to the at least one mobile client computer at least once daily as part of a daily work plan, the plurality of charge codes associating at least one work element to each of the one or more work activities, the at least one mobile client computer being configured for:
searching for work elements in the daily work plan;
displaying one or more work activities associated with an individual work element in the daily work plan; and
selection of an individual work activity for which work progress may be recorded.

28. The work project system of claim 24, the plurality of charge codes being provided to the at least one mobile client computer at least once daily as part of a daily work plan, the plurality of charge codes associating at least one work element to each of the one or more work activities, the at least one mobile client computer being configured for:
displaying an allocations grid, the allocations grid including a listing of one or more pieces of equipment among the plurality of equipment for which allocations may be made with respect to the daily work plan.

29. The work project system of claim 28, the allocations grid further showing, for each of the one or more pieces of equipment for which allocations may be made, a time allocated and any remaining time worked but not yet allocated.

30. The work project system of claim 24 being further configured for computing a performance factor for each piece of equipment among the plurality of equipment with respect to both a plan and a budget, the performance factors being calculated from the work progress data, how run time data for each piece of equipment has been allocated, and a planned amount of work progress in either the plan or the budget.

31. The work project system of claim 24 wherein the plurality of charge codes are provided to the at least one mobile client computer at least once daily as part of a daily work plan;
the work project system being further configured for computing performance factors for a piece of equipment among the plurality of equipment with respect to both the daily work plan and the budget, the performance factors being calculated from the recorded work progress data, how run time data for the piece of equipment has been allocated, and an amount of work progress included in either the daily work plan or the budget.

32. The work project system of claim 24 wherein the plurality of charge codes are provided to the at least one mobile client computer at least once daily as part of a daily work plan.

33. A system for evaluating the performance of equipment used in a work project, the system comprising a mobile client computer having a tangible computer readable medium with program instructions executable thereby, the system being configured for:
at least once daily, receiving from a central computer one or more charge codes associated with one or more work activities included in a daily plan for the work project and identification of one or more pieces of equipment included in the daily plan and available for use on the work project;
allowing a user to make a selection of a charge code among the one or more charge codes, the selected charge code being associated with a selected work activity among the one or more work activities;
allowing the user to make a selection of a piece of equipment among the one or more pieces of equipment;
receiving from the central computer run time data at least once daily for the selected piece of equipment, the run time data being automatically recorded by an electronic run time meter on the selected piece of equipment;
allowing the user to make an allocation of the run time data to the selected work activity based on the selected charge code;
allowing the user to enter work progress data towards completion of the selected work activity;
sending the allocation of the run time data and the work progress data to the central computer;
at least once daily in real-time following the allocation of the run time data and the work progress data, receiving from the central computer an equipment earned value and an equipment variance for the selected piece of equipment with respect to each of the daily plan and a budget for the selected work activity;
at least once daily in real-time following the allocation of the run time data and the work progress data, receiving from the central computer a plan performance factor for the selected piece of equipment with respect to the daily plan based on the work progress data, the allocation of the run time data, and a planned amount of daily work progress designated in the daily plan;
at least once daily in real-time following the allocation of the run time data and the work progress data, receiving from the central computer a budget performance factor for the selected piece of equipment with respect to the budget based on the work progress data, the allocation of the run time data, and a budgeted amount of work progress designated in the budget; and
displaying the equipment earned values, the equipment variances, the plan performance factor, and the budget performance factor to the user.

34. The system of claim 33 wherein:
the one or more charge codes comprises a plurality of charge codes associated with a respective plurality of work activities;
the one or more pieces of equipment comprises a plurality of pieces of equipment; and
the system receives an equipment earned value, an equipment variance, a plan performance factor, and a budget performance factor for each of the plurality of pieces of equipment for each respective selected work activity at least once daily in real-time following a respective allocation of run time data and work progress data.

35. The system of claim 34, the plurality of charge codes being provided to the mobile client computer at least once daily as part of a daily work plan, the system being further configured for:
allowing the user to make a selection of a work activity among the plurality of work activities; and
in response to the selection, providing a listing of one or more pieces of equipment among the plurality of equipment designated for use on the selected work activity in the daily work plan.

36. The system of claim 35 being further configured for:
displaying a work quantity allocation screen, the work quantity allocation screen displaying an amount of work progress designated in the daily work plan for a selected work activity, the work progress designated for the daily work plan being displayed in quantitative units suitable for characterizing work progress for the selected work activity;
the work quantity allocation screen providing for input of actual work progress in the same quantitative units as displayed in the daily work plan.

37. The system of claim 34, the plurality of charge codes being provided to the mobile client computer at least once daily as part of a daily work plan, the plurality of charge codes associating at least one work element to each of the one or more work activities, the mobile client computer being configured for:
searching for work elements in the daily work plan;
displaying one or more work activities associated with an individual work element in the daily work plan; and
selection of an individual work activity for which work progress may be recorded.

38. The system of claim 34, the plurality of charge codes being provided to the mobile client computer at least once daily as part of a daily work plan, the plurality of charge codes associating at least one work element to each of the one or more work activities, the mobile client computer being configured for:
displaying an allocations grid, the allocations grid including a listing of one or more pieces of equipment among the plurality of equipment for which allocations may be made with respect to the daily work plan;
the allocations grid further showing, for each of the one or more pieces of equipment for which allocations may be made, a time allocated and any remaining time worked but not yet allocated.
